(19) United States
(12) Patent Application Publication
(10) Pub. No.: US 2026/0143025 A1
(43) Pub. Date: May 21, 2026

(54) STREAMLINING EDGE-CLOUD-NATIVE APPLICATION DEVELOPMENT AND DEPLOYMENT WITH ROBUST ENCAPSULATION

(71) Applicants: UNIVERSITY OF NORTH TEXAS, Dallas, TX (US); THE UNIVERSITY OF CHICAGO, Chicago, IL (US)

(72) Inventors: Mohsen Amini SALEHI, Dallas, TX (US); Pawissanutt LERTPONGRUJIKORN, Dallas, TX (US); Hai Duc NGUYEN, Chicago, IL (US)

(21) Appl. No.: 19/394,309

(22) Filed: Nov. 19, 2025

Related U.S. Application Data
(60) Provisional application No. 63/722,466, filed on Nov. 19, 2024.

(51) Int. Cl. H04L 67/10; H04L 41/5019

(52) U.S. Cl. CPC H04L 67/10; H04L 41/5019

(57) ABSTRACT

A method for providing object-based serverless computing across distributed computing infrastructure includes receiving one or more class definitions that encapsulate application logic as methods, application state as attributes, and Quality of Service (QoS) requirements as declarative service level agreements (SLAs), selecting one or more runtime templates based on said SLAs that define a deployment architecture optimized for specific combinations of quality-of-service requirements, instantiating one or more class runtimes from said selected runtime templates across one or more computing tiers, deploying application components across said computing tiers according to said class runtimes, and automatically enforcing said SLAs through resource allocation and runtime adaptation without manual configuration.

### CROSS-REFERENCE TO RELATED APPLICATIONS

This application claims the benefit of U.S. Provisional Application No. 63/722,466, filed on Nov. 19, 2024, and entitled “STREAMLINING CLOUD-NATIVE APPLICATION DEVELOPMENT AND DEPLOYMENT WITH ROBUST ENCAPSULATION”, which is incorporated herein by reference in its entirety for all purposes.

### STATEMENT REGARDING FEDERALLY FUNDED RESEARCH OR DEVELOPMENT

None.

### FIELD

The present disclosure relates generally to cloud computing and serverless computing systems. More particularly, the disclosure relates to systems and methods for providing unified object-based abstractions for serverless function deployment across cloud, edge, and Internet-of-Things (IoT) environments with automated enforcement of declarative quality-of-service (QoS) requirements.

### BACKGROUND

In recent years, Function-as-a-Service (FaaS or Serverless) has emerged as a transformative paradigm within the realm of cloud computing, redefining how businesses and individuals develop and deploy cloud applications. As a departure from traditional virtualized infrastructure such as virtual machines, FaaS offers on-demand execution of code in response to events without the need to manage servers or underlying infrastructure. Application developers leverage FaaS through high-level abstractions provided by various cloud platforms, enabling them to focus on writing and executing functions rather than dealing with complex hardware and software management, significantly enhancing productivity.

### SUMMARY

In some embodiments, a method for providing object-based serverless computing across distributed computing infrastructure comprises receiving one or more class definitions, selecting one or more runtime templates based on said SLAs, instantiating one or more class runtimes from said selected runtime templates across one or more computing tiers, deploying application components across said computing tiers according to said class runtimes, and automatically enforcing said SLAs through resource allocation and runtime adaptation without manual configuration. Each class definition encapsulates application logic as methods, application state as attributes, and quality-of-service requirements as declarative service level agreements (SLAs), and each runtime template defines a deployment architecture optimized for specific combinations of quality-of-service requirements.

In some embodiments, a system for distributed object-based serverless computing comprises a deployment manager configured to receive class definitions specifying object-oriented abstractions with methods, attributes, and service level agreements (SLAs), and to coordinate deployment across multiple computing tiers, a runtime manager at each computing tier configured to select runtime templates based on SLAs and infrastructure characteristics, and to instantiate runtimes for managing objects, a plurality of runtimes configured to execute functions implementing object methods, manage object state, enforce consistency requirements, and coordinate inter-tier communication, a communication infrastructure providing location-transparent messaging across computing tiers, and an adaptation system configured to monitor compliance with said SLAs and trigger automatic adjustments to resource allocation, replica placement, and request routing in response to workload changes, infrastructure conditions, and network events.

In some embodiments, a method for enforcing quality-of-service requirements in distributed serverless applications comprises receiving declarative service level agreements (SLAs) specifying one or more of throughput requirements, availability requirements, consistency requirements, and locality requirements, determining resource allocation across multiple computing tiers to satisfy said SLAs, comprising calculating a replication factor based on availability requirements and infrastructure reliability metrics, deploying application components with pre-warmed execution environments to guarantee throughput requirements, configuring data consistency mechanisms selected from consensus protocols, conflict-free replication, session-based consistency, and eventual consistency based on said consistency requirements, routing requests to computing locations proximate to associated data using distributed hash-based tracking to enforce locality requirements, continuously monitoring actual performance against said SLAs, and dynamically adapting said resource allocation, replication factor, consistency mechanisms, and request routing in response to detected performance deviations, infrastructure changes, and network conditions.

These and other features will be more clearly understood from the following detailed description taken in conjunction with the accompanying drawings and claims.

### BRIEF DESCRIPTION OF THE DRAWINGS

FIGS. 1A-1B 1 schematically illustrate how Object-as-a-Service (OaaS) extends the FaaS abstraction to encapsulate everything into a single deployment with built-in non-functional enforcement, according to some embodiments.

FIGS. 2A-2B illustrate how FaaS limitations prevent applications from exploiting locality for performance and complicate deployment refinement.

FIG. 3 illustrates the System vs. FaaS approach to develop and deploy applications across Edge-Cloud continuum according to some embodiments.

FIG. 4 schematically illustrates FaaS-based development and deployment challenges according to some embodiments.

FIGS. 5A-5B schematically illustrate how limited non-functional support from the cloud introduces repeated and complex refinement processes for Quality of Service (QoS). In contrast, the OaaS abstraction outsources the refinement to the cloud provider with a well-defined set of information and refinement objectives. Thus, making the quality refinement more efficient and productive.

FIG. 6 schematically illustrates realizing objects with class runtime and template: OaaS maintains templates customized for various deployment scenarios. For a specific class, Oparaca uses one of its predefined templates to create a class runtime to manage the deployed classes optimally.

FIG. 7 schematically illustrates an overview of the System paradigm to resolve Edge-Cloud challenges for IoT applications according to some embodiments.

FIGS. 8A-8B illustrate the maximum read staleness (top) and average write latency (bottom) under different consistency-availability configurations. Numbers in parentheses show the replica count required to meet both guarantees.

FIGS. 9A-9C illustrate the achievable throughput varying target throughput. Oparaca ensures the actual throughput matches the target one across settings, while the other approaches fail to do so at high targets.

FIG. 10 illustrates the successful invocation rate at different availability targets with availability enforcement. Resource stability (P) is 94.36% (line).

FIG. 11 illustrates how Oparaca can exploit data locality to provide various latency guarantees according to some embodiments.

FIG. 12 schematically illustrates enforcing service level agreements (SLAs) through class deployment according to some embodiments.

FIG. 13 illustrates the Impact of network partitioning for classes with: RYW, RYW with throughput, and Strong Consistency.

FIGS. 14A-14B schematically illustrate developing and deploying a real-time inventory management system with FaaS and System. Head and should icons depict system components the developer has to interact during the application life cycle. System needs fewer component interactions and doesn't require the verify and tune loop to meet desired SLAs.

FIGS. 15A-15C illustrate the scalability analysis of System according to some embodiments.

FIG. 16 schematically illustrates the System architecture according to some embodiments.

FIG. 17 schematically illustrates a bird's-eye view of Oparaca's architecture according to some embodiments.

FIG. 18 schematically illustrates a Class Deployment with Class Runtime according to some embodiments.

FIGS. 19A-19B illustrates a latency of function invocation with increasing request rate and payload size in various baseline systems according to some embodiments.

FIG. 20 illustrates a class diagram for the image processing example according to some embodiments.

FIG. 21 shows an OaaS deployment for image processing according to some embodiments.

FIG. 22 illustrates modeling and implementing a simple IoT processing service with the system according to some embodiments.

FIG. 23 schematically illustrates LTAG (Latency, Throughput, and Availability Guarantee): An example of a class runtime template designed for enforcing class latency, throughput, and availability requirements (OSS: Open-source software) according to some embodiments.

FIG. 24 illustrates that Oparaca does not significantly differ in throughput performance across the FaaS engines.

FIGS. 25A-25C show error response ratio of different solutions upon deploying them with the different number of services according to some embodiments.

FIG. 26 schematically illustrates a case study of developing video and image processing for a real-time monitoring system according to some embodiments.

FIG. 27 illustrates rounds of refinement for Knative to enforce the target throughput versus Oparaca. Data points are annotated by #pods (#cores), including invoker pods.

For a detailed description of the aspects of the presently disclosed subject matter, reference will now be made to the accompanying drawings.

### DETAILED DESCRIPTION

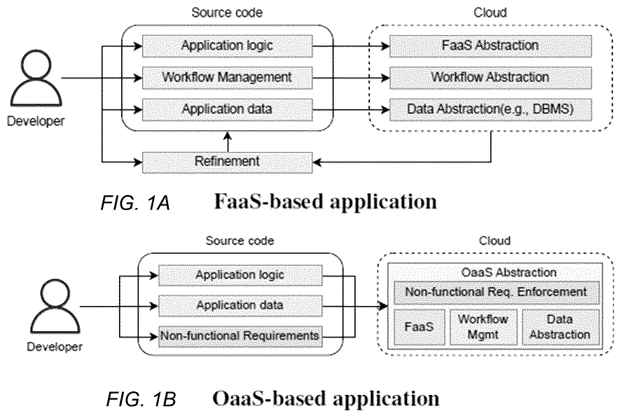

Unfortunately, beyond hiding complexity, Function-as-a-Service (FaaS or Serverless) plays a very limited role in other aspects. Primarily, FaaS functions only offer resource and computation abstraction, which is insufficient for complete application deployment. Developers must rely on additional cloud services, such as databases and orchestrators, to manage application states and workflows. Yet, there are limited integration supports among these abstractions. As illustrated in FIGS. 1A-1B 1, current FaaS-based applications require developers to separately manage application logic through FaaS abstraction, application data through data abstraction such as database management systems, and workflow management through separate workflow abstractions, all while undergoing multiple rounds of refinement to meet non-functional requirements.

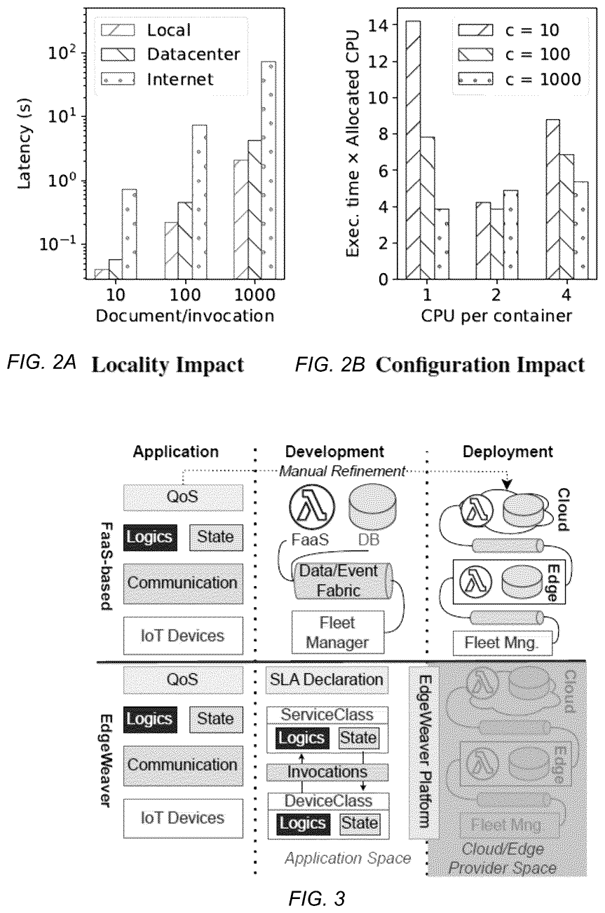

There is currently limited abstraction integration. FaaS applications are formed based on FaaS functions and additional cloud services, such as databases and workflow orchestrators. However, these abstractions typically operate independently. This independence creates challenges, as even a single functionality may involve multiple abstractions but lacks the capability to integrate them effectively. In stateful applications, for example, FaaS functions typically need access to an external database to read and update its state. This makes the application performance strongly depends on efficient data transmission between the FaaS invocations and the database. As demonstrated in FIGS. 2A-2B, the end-to-end latency of FaaS invocations modifying JSON documents from a database varies dramatically based on the database's location relative to the function's containers. Executing a function on the same machine as the database results in significantly faster performance than running the function from a different machine within the same data center or across the Internet. The latency difference increases substantially as more data is transmitted.

Developers refine application deployments through primitive resource-domain settings, like per-container CPU allocation. On the other hand, non-functional requirements are typically measured and evaluated using application-domain metrics, such as throughput, latency, and monetary cost. Translating these requirements into effective FaaS configurations is challenging. Configuring low-level parameters to produce a reliable and robust deployment demands significant effort and expertise, often necessitating numerous rounds of refinement. FIGS. 2A-2B also illustrates that considering only one factor for cost minimization is insufficient, and configuring multiple parameters together requires extensive trial and error without clear insights into optimal configurations.

The rise of complex, latency-sensitive IoT applications across Edge-Cloud continuum exposes additional limitations of current FaaS platforms in seamlessly addressing the complexity, heterogeneity, and intermittent connectivity of Edge-Cloud environments. Developers are left to manage integration and Quality of Service (QoS) enforcement manually, rendering application development complicated and costly. As shown in FIG. 3, the FaaS-based approach to developing and deploying applications across the Edge-Cloud continuum requires significant manual effort from developers.

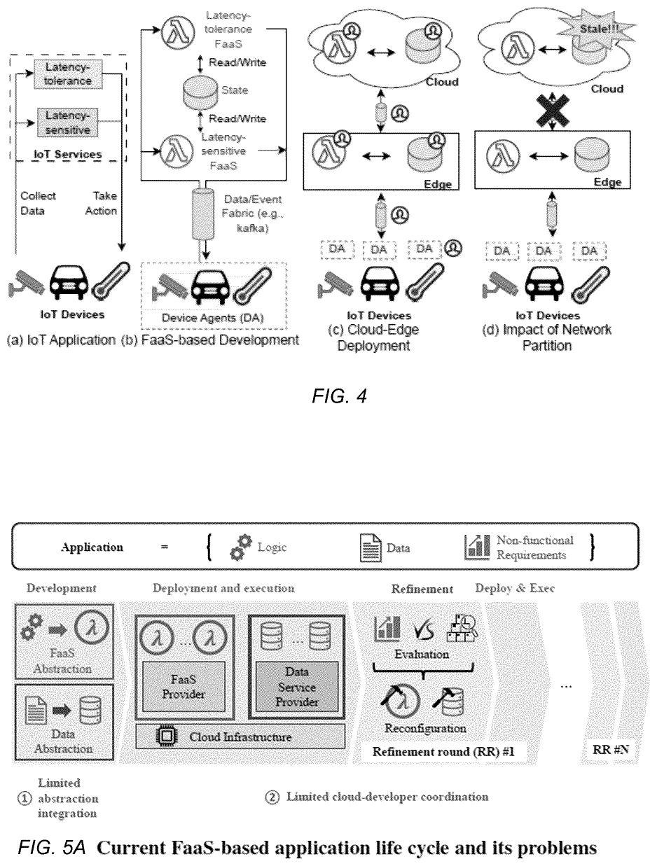

The heterogeneous nature of edge-cloud environments introduces additional challenges in managing and deploying IoT applications across the continuum. Due to resource limitations, FaaS abstractions on the edge such as using lightweight Kubernetes distributions (e.g., k3s) differ from their cloud counterparts such as using k8s, increasing deployment complexity. Large-scale IoT solutions span diverse technologies, application models, and communication protocols. Coordinating such heterogeneous environments remains a major challenge. As illustrated in FIG. 4, even with a single edge deployment, developers must implement and manage numerous components, and this complexity escalates with additional edge sites, as each node may differ in software stacks, capacity, network conditions, and policies.

The Edge-Cloud continuum often suffers from intermittent connectivity between tiers, caused by network congestion, physical obstructions, power limitations, or fluctuating bandwidth. Lost or delayed connections, that is, network partition, can disrupt data flow, causing communication delays or losses. This undermines consistency, as the cloud's view of the application's state becomes stale while the edge node continues processing data locally. FIG. 4 demonstrates the impact of network partitions on Edge-Cloud deployments, showing how connectivity loss can lead to stale data and inconsistent system states.

The CAP theorem formally shows that simultaneously guaranteeing consistency and availability under network partitions is impossible. Consequently, Edge-Cloud IoT deployments must carefully adapt their design to balance trade-offs among consistency, availability, and performance for their application's specific QoS needs.

As a result of these limitations described herein, delivering efficient cloud and edge-cloud applications is complicated and expensive. The refinement phase consists of multiple rounds of reconfiguration and deployments that cost a lot of time and effort. There exists a need for improved abstractions that can unify application logic, data, and non-functional requirements into a single deployment package; provide declarative interfaces for expressing quality-of-service requirements; automatically enforce non-functional requirements without manual refinement; support diverse deployment scenarios from cloud-only to heterogeneous edge-cloud continuum; handle intermittent connectivity and adapt to dynamic network conditions; support various consistency models appropriate for different application needs; and integrate seamlessly with IoT devices and fleet management systems.

The present disclosure addresses the foregoing needs by providing systems and methods for unified object-based abstractions in serverless computing environments spanning cloud, edge, and IoT infrastructure, with automated enforcement of declarative Quality of Service (QoS) requirements.

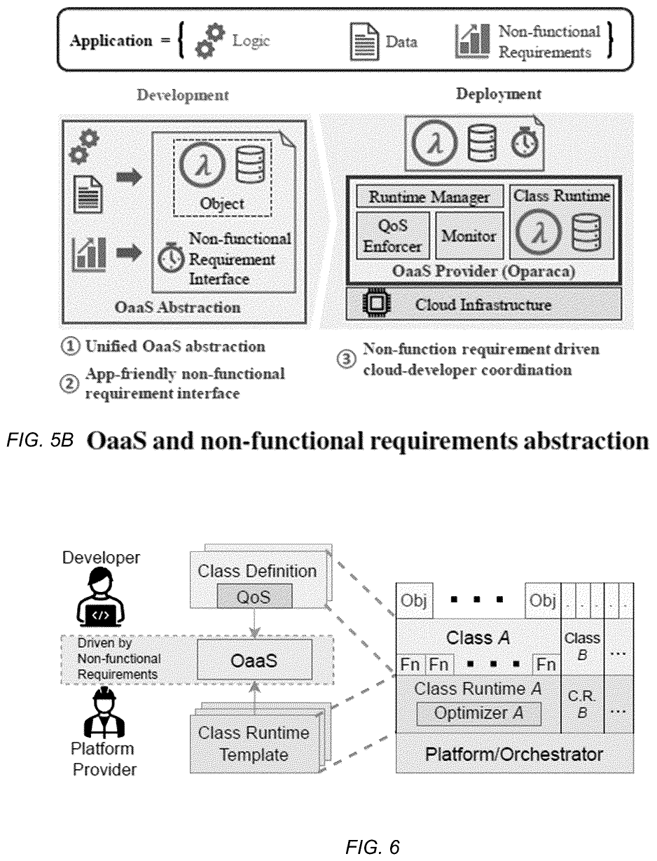

In one aspect, the disclosed systems and methods provide an Object-as-a-Service (OaaS) abstraction, a serverless paradigm that borrows object-oriented programming concepts to encapsulate application logic (that is, functions), data (that is, state), and non-functional requirements into a single deployment package. The OaaS abstraction allows developers to unify application functionality implementations into single packages, eliminating the multi-abstraction barriers that hinder productivity and efficiency. As illustrated in FIGS. 1A-1B and FIGS. 5A-5B, the OaaS abstraction extends the FaaS abstraction to encapsulate everything into a single deployment with built-in non-functional enforcement, boosting productivity and efficiency while eliminating the need for multiple rounds of manual refinement.

The abstraction also comes with a “non-functional requirement interface” that allows applications to declare expected QoS requirements and constraints as high-level and measurable metrics. Developers can use the interface to express their requirements, and then the cloud provider will enforce them automatically, removing the need for repeated refinements.

To efficiently satisfy diverse non-functional requirement combinations, the present systems and methods introduce class runtime templates, which provide configurable class runtime designs optimized for specific sets of requirement combinations. The platform maintains a list of different templates to support as many requirement combinations as possible. When deploying a class, the system chooses from the list the most suitable template to realize the class requirements and then follows the template design to create a dedicated class runtime for the class. FIG. 6 illustrates how Oparaca realizes objects with class runtimes and templates, maintaining templates customized for various deployment scenarios and using predefined templates to create class runtimes that manage deployed classes optimally. Oparaca is an open-source platform that implements and realizes the Object-as-a-Service (OaaS) paradigm for serverless cloud computing.

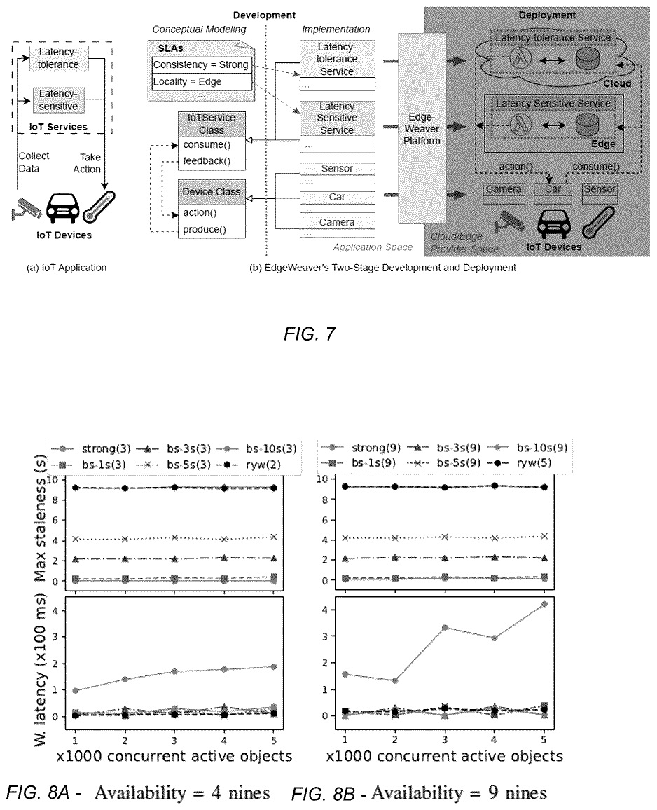

In some aspects, the systems and methods extend the OaaS paradigm to the Edge-Cloud continuum for IoT applications. The system provides a unified “object” abstraction that is seamlessly distributed across the continuum to encapsulate application logic, state, and QoS. The platform automates “class” deployment across edge and cloud, enabling developers to declaratively express QoS such as availability and consistency desires that, in turn, guide internal resource allocation, function placement, and runtime adaptation to fulfill them. FIG. 7 provides an overview of the disclosed platform paradigm, showing how it resolves Edge-Cloud challenges for IoT applications through a two-stage development process involving conceptual modeling and implementation. The disclosed platform can be referred to herein as “EdgeWeaver”, which is a platform that offers a unified object abstraction seamlessly distributed across the Edge-Cloud continuum to encapsulate application logic, state, and QoSrequirements, thereby streamlining IoT application development and deployment. The platform automates class deployment across edge and cloud infrastructure, enabling developers to declaratively express QoS desires such as availability and consistency that guide internal resource allocation, function placement, and runtime adaptation to fulfill those requirements without manual intervention.

The disclosed systems and methods further include lightweight Device Agents (DA) that run on IoT devices, exposing platform-specific Application Programming Interface (API(s)) to integrate these devices into the platform environment. Heterogeneous IoT devices are modeled by a Device class, defining their basic operations such as produce data and take action with other IoT services, which are also modeled as separate classes. FIG. 7 shows how Device Agents enable seamless integration of IoT devices into the EdgeWeaver platform.

The disclosed systems and methods support multiple consistency models appropriate for different deployment scenarios. Strong consistency ensures that all replicas agree on the latest object states before processing reads or writes, using consensus protocols such as Raft. Raft is a consensus protocol used in distributed systems to ensure that multiple replicas of data agree on the latest state, even when some replicas may fail or network issues occur. Bounded-Staleness Consistency allows stale reads within a time-bound, employing anti-entropy techniques with Merkle-Search Trees to detect and repair inconsistencies within the defined window, along with CRDTs to manage out-of-order changes. Read-Your-Write (RYW) Consistency allows reads to see a recent write from the same source, even under network partition, by routing reads and writes through the object access API to the same local storage. The system also supports Eventual Consistency, which allows temporary divergence with eventual convergence, as well as Sequential and Linearization Consistency, which provide ordered consistency guarantees. FIGS. 8A-8B demonstrates the maximum read staleness and average write latency under different consistency-availability configurations, showing that EdgeWeaver consistently enforces the specified consistency guarantees across all configurations.

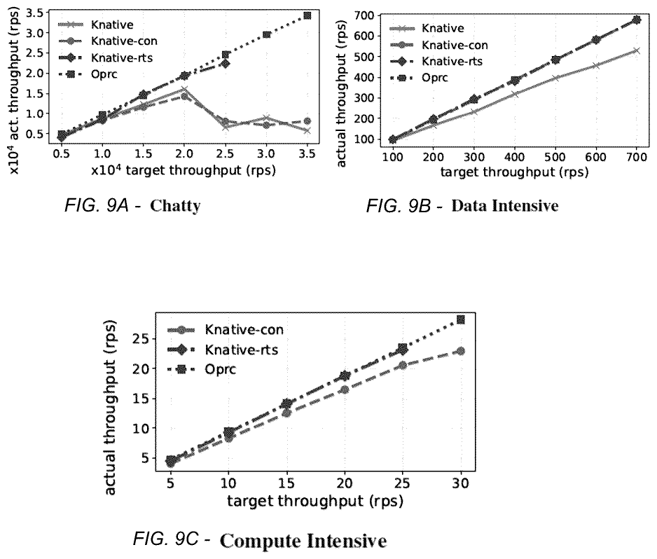

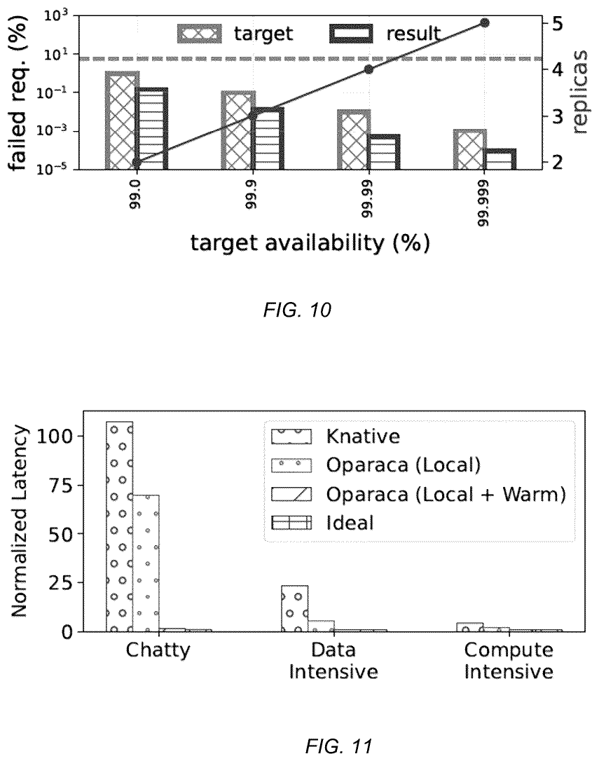

The disclosed systems and methods automatically enforce various QoS requirements. Throughput Enforcement provides a minimum number of invocations guaranteed to be executed per second through resource allocation and pre-warming. FIGS. 9A-9C demonstrates that Oparaca ensures actual throughput matches the target throughput across all application settings, while other approaches fail to do so at high targets. Availability Enforcement ensures a percentage of time objects or functions are available through replication calculated based on resource stability. FIG. 10 shows successful invocation rates at different availability targets with availability enforcement, demonstrating that increasing availability significantly with a limited resource cost (e.g., increasing availability from 99% to 99.999% incurs only 2.5 times extra resource cost). Latency Enforcement minimizes system overhead through locality guarantees and cold-start elimination, as illustrated in FIG. 11, which shows that Oparaca can exploit data locality to provide various latency guarantees, achieving invocation execution latency very close to ideal execution. Locality Enforcement places invocations close to their data using consistent hashing to track object data locations.

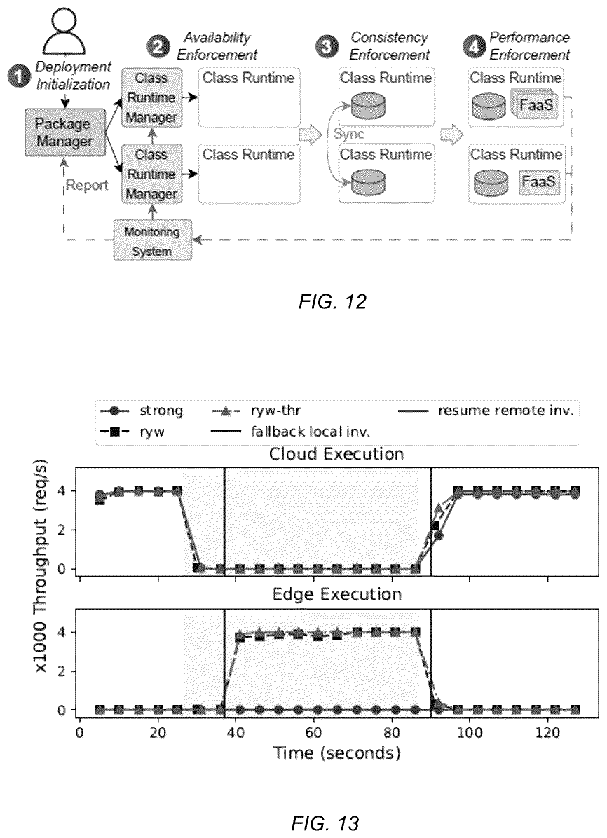

The system includes monitoring and adaptive management capabilities that continuously collect QoS-related metrics and automatically adjust deployments in real-time to maintain SLA compliance during workload fluctuations, resource availability changes, and network conditions including network partitions. FIG. 12 illustrates how EdgeWeaver enforces SLAs through class deployment, with the Package Manager, Class Runtime Manager, and Monitoring System working together to ensure SLA compliance during deployment and execution. FIG. 13 demonstrates the impact of network partitioning on classes with different consistency models, showing EdgeWeaver's fine-grained adaptability in dynamically balancing QoS desires in response to network changes.

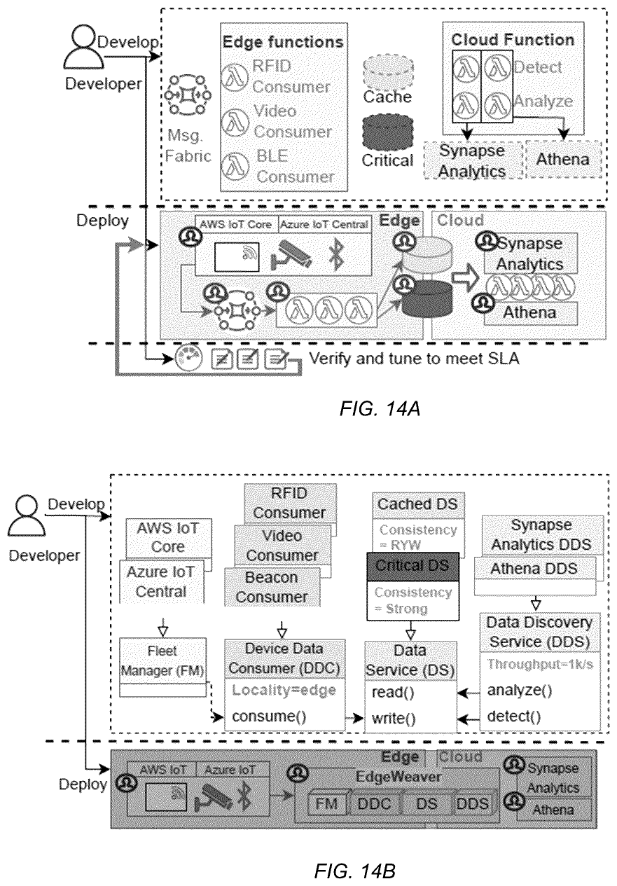

The disclosed platform, system, and methods provides numerous advantages over prior systems. First, regarding productivity, applications no longer need to consider low-level resource configuration for non-functional requirements, relieving the burden of performance optimization from deployment processes. Evaluations demonstrate faster development time, a reduction in lines of code, and 10-fold reduction in configuration code. FIGS. 14A-14B shows a comprehensive comparison of developing and deploying a real-time inventory management system using FaaS-based solutions (FIG. 14A) versus EdgeWeaver (FIG. 14B), demonstrating the significant reduction in component interactions and elimination of the verify-and-tune loop.

Second, regarding portability, as long as the provider supports the abstraction, applications can rely on the object abstraction to maintain functionality, meet QoS and constraint expectations, and comfortably deploy across scenarios with minimal changes. Third, regarding cloud-application symbiosis, the interface acts as a “glue” to make symbiosis between the cloud and the application developer, providing valuable guidelines for cloud service providers and useful means of communication for developers.

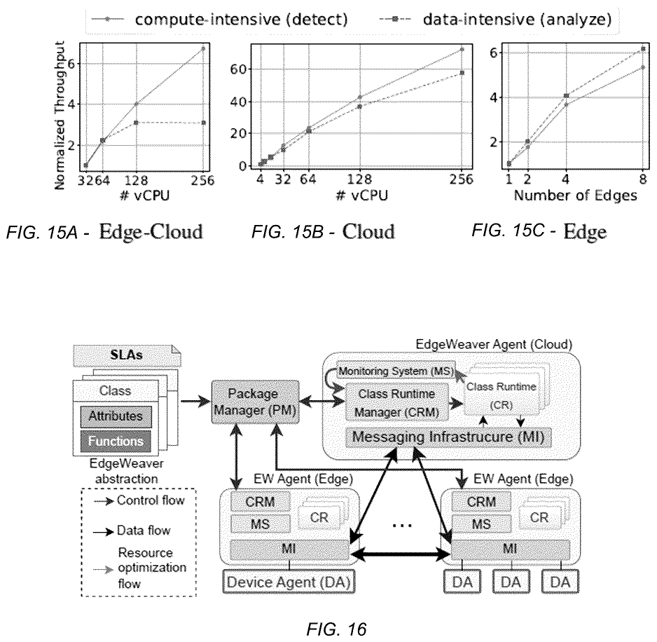

Fourth, regarding performance improvements, evaluations demonstrate that the disclosed systems and methods can enhance application performance by up to 60 times and improve reliability by up to 50 times through latency, throughput, and availability enforcement, with remarkably less development and deployment time and effort. The system can achieve up to 70 times throughput scaling while maintaining SLA compliance. FIGS. 15A-15C show the scalability analysis of EdgeWeaver, demonstrating strong scalability with throughput increasing nearly linearly up to certain resource allocations.

Fifth, regarding extreme reliability, the system can achieve nine nines availability (99.999999999%), which is 10,000 times more reliable than the current standard, at only 3 times the cost. Sixth, regarding adaptability, SLA-driven deployment enables automatic adaptation to dynamic environments including network partitions, consistently meeting application needs without manual intervention.

The present systems and methods provide a comprehensive platform for deploying and managing serverless applications across cloud, edge, and IT infrastructure. The platform architecture includes several key components that work together to provide unified object abstraction and automated QoS enforcement.

The core platform components can comprise the package manager, the class runtime manager, class runtime, monitoring system, has-aware load balancer and container runtime, messaging infrastructure, and device agents. Each of the core platform components can be implemented in software operating on the systems described in more detail herein.

The Package Manager serves as the deployment gateway and is responsible for managing classes registered in the platform and their corresponding deployment packages. This component offers APIs to develop and deploy applications based on the object-as-a-service paradigm. Upon registration, the Package Manager unpacks the deployment, extracting the class logic such as functions, state such as data schema, and non-functional requirements such as QoS and constraints. In edge-cloud deployments, the Package Manager forwards relevant class definitions to corresponding platform agents operating in target data centers based on the list of data centers the application is authorized to access. FIG. 16 provides an overview of the EdgeWeaver architecture, showing how the Package Manager coordinates with other components across cloud and edge tiers.

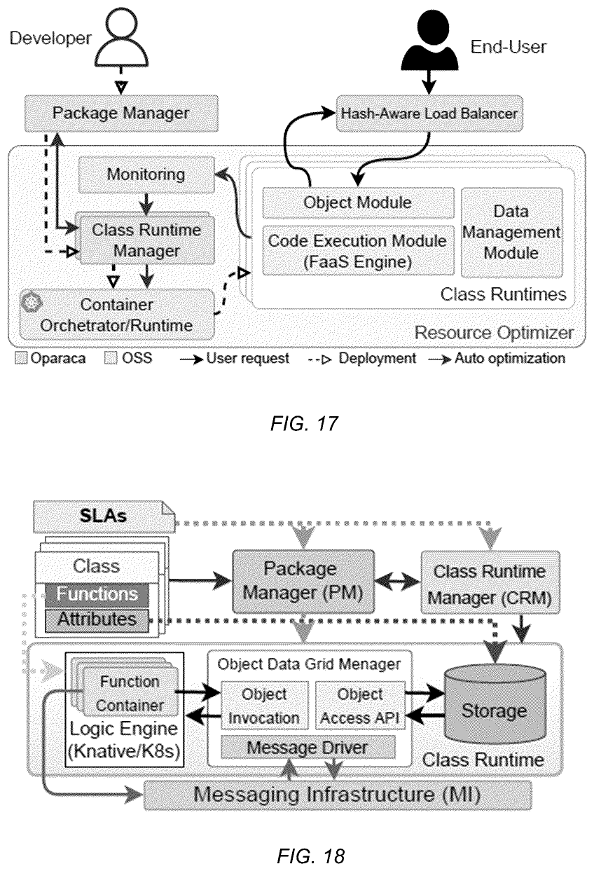

The Class Runtime Manager creates dynamic class runtimes from existing templates such as the LTAG template for Latency, Throughput, and Availability Guarantee. It is responsible for class runtime deployment and management. The extracted information from the Package Manager is forwarded to the Class Runtime Manager to find an appropriate class runtime template to generate a dedicated class runtime to handle the object realization for the class. Each tier across Edge-Cloud can host a platform agent that includes a Class Runtime Manager that adjusts deployments in real-time, forming a localized control loop that continuously adapts to workload fluctuations, resource availability, and network conditions without manual tuning. FIG. 17 shows a bird's-eye view of Oparaca's architecture, illustrating how the Class Runtime Manager creates dynamic class runtimes and manages their deployment.

Class Runtimes turn the class descriptions and corresponding packages into actual object deployments on the cloud or edge infrastructure. Each Class Runtime is responsible for managing the execution and state of all objects generated from the associated class. In one embodiment, each Class Runtime comprises three key components. The Logic Engine executes class methods, which may be implemented using existing FaaS engines such as Knative, OpenFaaS, or Fission. The Storage System instantiates appropriate storage backends for managing object attributes based on their data types and consistency requirements, supporting both structured data such as document databases and unstructured data such as object storage. The Object Data Grid Manager (ODGM) orchestrates invocations and data access using modules for invocation routing, data consistency enforcement, and cross-datacenter communication. FIG. 18 illustrates class deployment with Class Runtime, showing the three key components and their interactions.

The Monitoring System gathers performance metrics from class runtimes. Based on the collected information, the platform can adjust the Container Orchestrator or Runtime to improve efficiency and take administrative actions such as recovering from failure if needed. The system continuously collects SLA-related metrics that are reported to the Package Manager and the Class Runtime Manager for automated adaptation.

The Hash-Aware Load Balancer and Container Runtime are responsible for scheduling and managing function execution. Once a function invocation is issued, the hash-aware load balancer routes the request to the corresponding class runtime by using consistent hashing that, in turn, forwards the request to the corresponding container for execution.

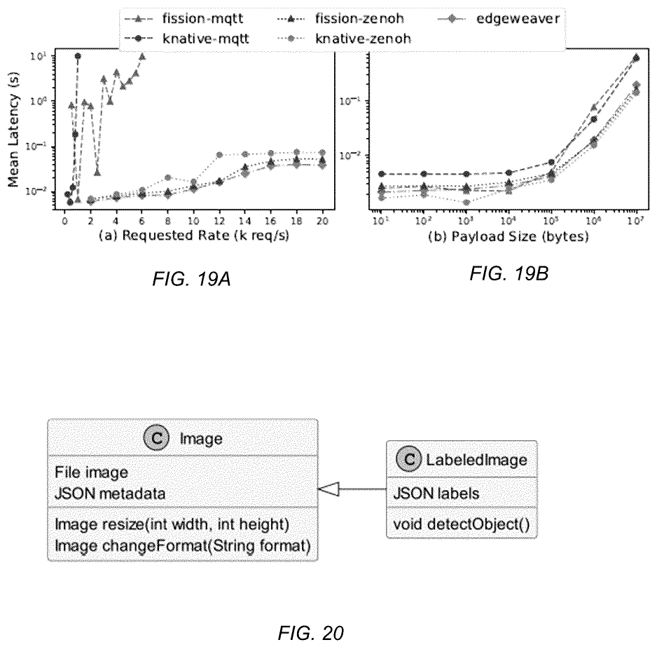

In edge-cloud deployments, a Messaging Infrastructure (MI) component abstracts inter-object communication into a topic-based protocol-agnostic model. In one embodiment, the system can use Zenoh, a low-latency publish/subscribe and query-based protocol that enables efficient coordination across the Edge-Cloud continuum. The Messaging Infrastructure enables seamless, location-transparent invocation across heterogeneous infrastructure. FIGS. 19A-19B shows the latency of function invocation with increasing request rate and payload size in various baseline systems, demonstrating that EdgeWeaver consistently delivers performance on par with or better than baselines despite introducing additional mechanisms for object abstraction and SLA enforcement.

For IoT applications, lightweight Device Agents (DA) run on IoT devices, exposing platform-specific APIs to integrate these devices into the platform environment. These agents enable IoT devices to interact with the broader application ecosystem through the unified object abstraction.

For edge-cloud deployments, the system employs a distributed architecture where platform agents are deployed at each tier including cloud and edge. Each agent includes a Package Manager for coordinating deployment and synchronization across tiers; a Class Runtime Manager with localized control loops; a Monitoring System for gathering SLA-related metrics; and a Messaging Infrastructure for cross-tier communication. This distributed architecture enables platform-wide consistency and scalable, hybrid Edge-Cloud deployments while maintaining local autonomy for adaptation to tier-specific conditions. FIG. 16 shows the distributed architecture with EdgeWeaver agents deployed at both cloud and edge tiers, each containing the necessary components for autonomous operation.

The present systems and methods extend the FaaS abstraction into an Object-as-a-Service (OaaS) abstraction that borrows object-oriented programming (OOP) concepts to unify application logic and data within a single abstraction. Each application is defined as a collection of cloud objects where its data, also known as state, is modeled as “attributes” with supported data types, and its logic is modeled as methods realized by serverless functions.

Within the OaaS abstraction, applications are built on the foundation of classes. Each class defines the structure of independent executable objects that are responsible for carrying out one or multiple functionalities. A class definition includes attributes representing state or data, which can be structured data in the form of schemaless JSON similar to document databases or unstructured data in the form of BLOBs stored in object storage, methods implemented as serverless functions that encapsulate application logic, and non-functional requirements, which are declarative specifications for QoS and constraints at the class, method, or attribute level.

The objects include OOP features. The abstraction offers the notions of abstract class, inheritance, and polymorphism to establish software reuse across cloud objects, thereby avoiding redundancy and enhancing development productivity. These features promote modular design and reduce code duplication. Inheritance follows OOP principles where non-functional requirement declarations are treated as properties of classes or methods and are enforced according to inheritance rules. If a method and its class have conflicting requirements, then the method-level requirement can prevail. FIG. 20 shows a class diagram for an image processing example where the developer can translate the class diagram directly to cloud deployment through the OaaS abstraction, demonstrating inheritance relationships between Image and LabelledImage classes.

The platform leverages OOP access modifiers and object composition features to organize application structure and encapsulate application flow through function calls. The object abstraction provides richer information for optimization and grants the cloud more control over the deployment to exploit them. For example, the abstraction lets application data and logic be encapsulated and managed together under the object abstraction. Thus, the system can easily find the data associated with each method and proactively distribute them across cloud database instances that are close to the deployed method, thereby minimizing data transmission overhead.

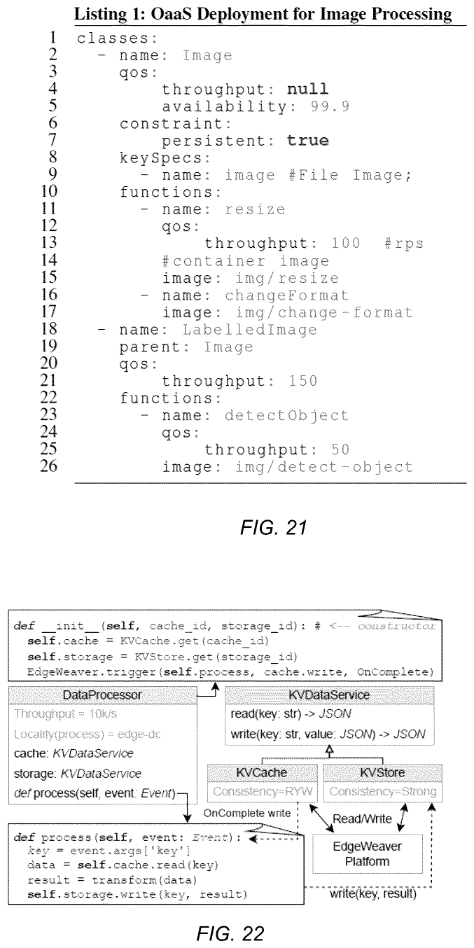

In some aspects, the system provides a deployment interface in YAML format for defining entities of cloud-native applications and non-functional requirements akin to OOP concepts. YAML (which stands for “YAML Ain′t Markup Language”) is a human-readable data serialization format commonly used for configuration files. An example specification as shown in FIG. 21 includes classes with names, QoS specifications including throughput and availability, constraints including persistence requirements, keySpecs defining attributes such as file images, and functions with their own QoS specifications and associated container images. This specification demonstrates inheritance where LabelledImage extends Image, method definitions with container images, and hierarchical non-functional requirements.

For edge-cloud deployments, the system provides a high-level API for inter-object communication, event-driven triggers, and system interactions, all without handling low-level details like networking protocols or deployment scripts. Object APIs include CLASS.create( ) to create a new object of class CLASS and return its ID, CLASS.get (ID) to retrieve an object of class CLASS by ID, and CLASS.delete (ID) to delete an object of class CLASS by ID. Attribute APIs include commit (obj, attr) to write local changes of attr in obj to storage, and refresh (obj, attr) to read the latest value of attr in obj from storage. Function APIs include trigger (func, src, e) to trigger func when event e occurs on src, and suppress (func, src, e) to disable trigger on func from src on event e. Events can include OnComplete or OnFailure for functions, or OnCreate, OnUpdate, or OnDelete for attributes. Table I provides a comprehensive listing of EdgeWeaver's API with detailed explanations.

TABLE I
System API

| Categories | API | Explanation |
|---|---|---|
| Object APIs | CLASS.create( ) | Create a new object of class CLASS and return its ID. |
| | CLASS.get(ID) | Retrieve an object of class CLASS by ID. |
| | CLASS.delete(ID) | Delete an object of class CLASS by ID. |
| Attribute APIs | commit(obj, attr) | Write local changes of attr in obj to storage. |
| | refresh(obj, attr) | Read the latest value of attr in obj from storage. |
| Function APIs | trigger(func, src, e) | Trigger func when event e occurs on src. Events: OnComplete or OnFailure if src |
| | | is a function; OnCreate, OnUpdate, or OnDelete if src is an attribute. |
| | suppress(func, src, e) | Disable trigger on func from src on event e. |

FIG. 22 illustrates how the abstraction supports comprehensive, infrastructure-independent application development through an example of an IoT data processing service implemented by the DataProcessor class that consumes data from a short-term cache, processes it, and writes it to a long-term store. The figure demonstrates how developers define a base class KVDataService and extend it into KVCache and KVStore through inheritance, with EdgeWeaver managing all object instantiations and data handling internally while developers simply attach SLA annotations such as Consistency equals Strong on KVStore to ensure strict linearizability without manually configuring consensus protocols.

The present systems and methods provide a non-functional requirement interface that lets developers express their non-functional requirements in a human-friendly manner. Through the interface, developers can declare their non-functional requirements for a whole object or even for a specific part, whether attribute or method, of it. The requirements are defined as high-level and measurable metrics either in the form of QoS requirements or deployment constraints. The following table presented as Table II presents a set of non-functional requirements and constraints supported by the system.

TABLE II

| | | | |
|---|---|---|---|
| Name | Value Type | Unit | Definition |

QOS Requirements

| | | | |
|---|---|---|---|
| Throughput | Integer | Rps | Minimum number of invocations guaranteed to be executed per |
| | | | second |
| Availability | Real | Percent | The percentage of time an object/function must be |
| | | | available for service. |
| Locality | {Local, None} | N/A | How function invocations are dispatched with respect to object |
| | | | state location. |

Deployment Constraints

| | | | |
|---|---|---|---|
| Persistent | Yes/No | N/A | Should the data associated with the object persistent |
| Runtime Req. | Dict | N/A | Specific object runtime configuration. (e.g., choice of FaaS engine) |
| Budget | Integer | Credit | Object deployment and operation budget. All costs must not exceed |
| | | | this value. |
| Consistency | Enumerate | N/A | Object consistency model: eventual, sequential, linearization, or none. |
| Jurisdiction | Enumerate | N/A | Candidate places to deploy an object |
| Data Encryption | Enumerate | N/A | Specify or disable the encryption algorithm for the stored data |

Under QoS Requirements, throughput is specified as an integer in requests per second (RPS), defining the minimum number of invocations guaranteed to be executed per second. Availability is specified as a real number percentage, defining the percentage of time an object or function must be available for service. Locality can be specified as preferred datacenters or as Local or None values, defining how function invocations are dispatched with respect to object state location or preferred data centers for deployment.

Under Deployment Constraints, Persistent is a yes or no value specifying whether the data associated with the object should be persistent. Runtime Requirements are specified as a dictionary defining specific object runtime configuration such as choice of FaaS engine. Budget is specified as an integer credit value defining object deployment and operation budget where all costs must not exceed this value. Consistency is specified as an enumeration defining the object consistency model, which can be Read Your Write (RYW), Bounded Staleness with a delta seconds parameter, Strong, eventual, sequential, linearization, or none. Jurisdiction is specified as an enumeration defining candidate places to deploy an object. Data Encryption is specified as an enumeration to specify or disable the encryption algorithm for the stored data.

During deployment, the cloud provider takes these non-functional requirements as input to its internal services and adjusts their operations to meet the requirements. The declared SLAs guide the platform's automated deployment process, ensuring that applications meet their QoS targets without manual intervention. By structuring application logic and state as objects, the system has a unified view to efficiently allocate resources, proactively distributing functions and associated data together to minimize latency and data transfer overhead. This SLA-driven resource management not only improves runtime efficiency but also adapts to dynamic conditions and infrastructure heterogeneity, enabling seamless and reliable execution.

To meet the requirement of efficiency, the class runtime must be controlled to fulfill non-functional requirements within reasonable cost and overhead. However, given the diversity of possible non-functional requirement combinations, it is impractical to have a single design for the class runtime that can efficiently satisfy all requirements. To resolve this problem, the system introduces class runtime templates, which provide configurable class runtime designs optimized for specific sets of requirement combinations. The platform maintains a list of different templates to support as many requirement combinations as possible. When deploying a class, the system chooses from the list the most suitable template to realize the class requirements and then follows the template design to create a dedicated class runtime for that class.

The template-based approach provides several advantages. First, regarding portability, the class runtime template enables flexibility in realizing objects. Instead of seeking a one-size-fits-all object realization mechanism, the system decomposes the object realization into a set of sub-problems, each aiming to find the optimal solution for a specific infrastructure setting and requirement combination. One can upgrade existing solutions, extend the implementation to include new non-functional requirements, or adjust for new infrastructure by adding or modifying templates without compatibility issues.

Second, regarding efficiency, the system can use off-the-shelf solutions to implement its class runtime templates. This allows the platform to take advantage of a vast diversity of existing state-of-the-art solutions, which have been proven efficient in practice, to reliably enforce non-functional requirements at minimum time, cost, and effort. Third, regarding customization, since class runtime templates are configurable, depending on specific object deployment scenarios, the class runtime derived from the template can be customized for further efficiency. The platform also allows providers to customize template configurations, selection conditions, and priority for their operation objectives such as resource utilization.

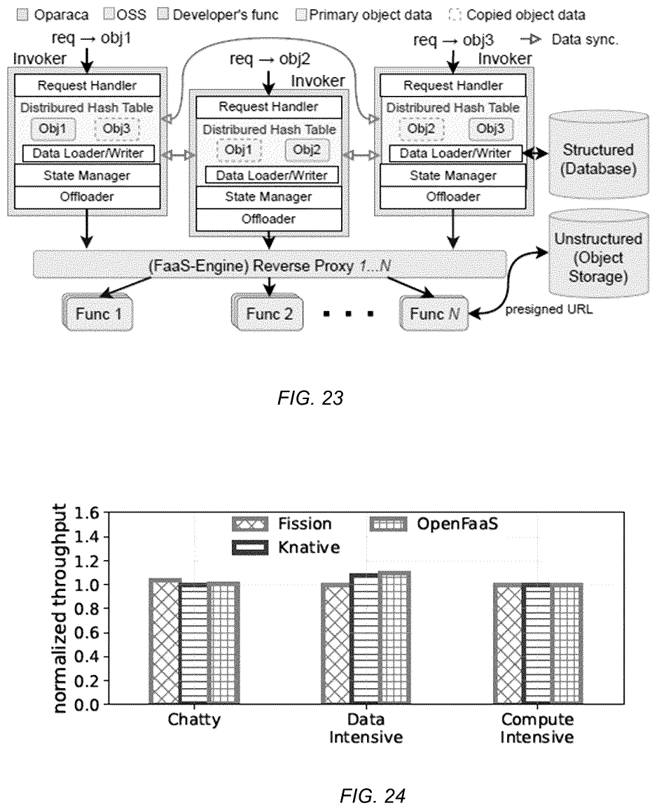

One embodiment implements the LTAG (Latency, Throughput, and Availability Guarantee) class runtime template for enforcing class latency, throughput, and availability requirements. Each class runtime derived from the template comprises three modules: invoker, FaaS engine, and data storages. FIG. 23 shows the LTAG template as an example of a class runtime template designed for enforcing class latency, throughput, and availability requirements, illustrating the invoker modules, FaaS engine, and data storage components along with their interactions.

The invoker is responsible for handling all object-related operations. For each operation, the invoker finds its corresponding function and offloads the operation to that function managed by the FaaS engine. The invoker utilizes a pure function approach that bundles the invocation request and the object attributes as a standalone task within a FaaS engine. Each invocation takes the object attributes as input, modifies them, and then returns the updated attributes as the output to the invoker. The invoker maintains an internal in-memory distributed hash table (DHT) to keep the object data, that is, attributes and metadata, for reducing database access operations, thereby speeding up object invocations.

The FaaS engine executes the actual function logic within containers. The system can utilize existing FaaS implementations such as Knative, OpenFaaS, or Fission as the underlying FaaS engine. FIG. 24 demonstrates that Oparaca does not significantly differ in throughput performance across different FaaS engines including Fission, OpenFaaS, and Knative, showing the system's flexibility in utilizing various FaaS implementations.

The LTAG template can maintain object state in both unstructured formats using object storage and structured formats using document databases. For unstructured data, the invoker can generate presigned URLs to allow direct access between function containers and object storage, minimizing data transfer through the invoker.

The system supports throughput enforcement by providing a minimum number of invocations to be invoked immediately, meaning with no cold-start, per second. The template customizes the Invokers and FaaS engine to periodically readjust resources allocated to each class and its functions, ensuring they have sufficient resources to serve operation requests up to the rate specified in the throughput requirement. The system adopts the idea of guaranteed invocation rate, proposed in the context of Real-time Serverless computing, to estimate and make resource allocation adjustment decisions. If a throughput SLA is specified, containers are pre-warmed with sufficient compute resources, calculated using techniques from real-time Serverless, to meet the required invocation rate.

To enforce latency in a feasible and controllable way, the system offers guarantees to minimize the system overhead of invocation executions, focusing on cold-start and communication. Developers can address cold-start via throughput enforcement. For communication, the system provides a locality guarantee, allowing developers to specify the location for invocation dispatch, which can be either local, where attributes are read and written as if they are in the same FaaS container executing the function logic, or none, meaning no locality restriction.

The template enforces the local guarantee by exploiting the class function-attribute relationships. Specifically, the system uses consistent hashing, maintained by invokers, to track object data locations and route invocation requests to the corresponding place. This ensures invocations are executed where their data is located, minimizing data transmission latency. If a locality SLA specifies preferred data centers, the system ensures that those data centers reserve enough resources to meet both throughput and co-location requirements. The Class Runtime ensures that containers are deployed on the same machine as the object's storage to reduce access latency and pre-warms containers to avoid cold starts.

The system provides availability enforcement as a reliability guarantee, defining the percentage of time that an object or its methods are available for invocation execution. The template enforces availability through replication. Given an object with availability requirement A such as 99.99 percent, the system enforces A by creating N replicas of the object where N is defined according to the formula: N equals the ceiling of log of one minus A divided by log of one minus P, where P is the stability of the resources used to deploy the object.

At class deployment time, the Package Manager selects appropriate tiers, also known as datacenters, to host Class Runtimes, guided by the availability SLA. It estimates the failure probability of each data center using metrics such as uptime and network reliability collected from the Monitoring System. Based on these estimates and the desired availability target, it calculates the required replication factor. The Package Manager then selects the necessary number of data centers that satisfy developer-specified constraints such as locality. If no constraints are given, it defaults to a round-robin strategy for load balancing.

The template replicates the object data and uses the DHT to manage them. In one embodiment, it keeps only one object replica, called primary, active at a time. To enforce consistency, the primary object handles all state modifications and then commits the results across all replicas. If the primary replica fails, the system chooses one of the remaining replicas as the new primary.

The present system provides support for multiple consistency models appropriate for different application needs and deployment scenarios. This is particularly important for edge-cloud deployments where intermittent connectivity may prevent strong consistency guarantees during network partitions. When Class Runtimes are deployed, they provision storage and coordinate with each other to enforce the consistency SLA specified in the class definition.

For Strong Consistency, the system integrates consensus protocols, such as the Raft consensus protocol, into the Object Data Grid Manager's Object Access API to ensure that all replicas agree on the latest object states before processing reads or writes. In one embodiment, the system uses OpenRaft library to implement the Raft protocol. The ODGM maintains application state inside its embedded in-memory storage and ensures that writes are committed to a majority of replicas before acknowledging success.

This approach ensures linearizability, which is the strongest form of consistency where all operations appear to occur instantaneously at some point between their invocation and completion. However, during network partitions that prevent quorum, writes are blocked to preserve correctness, trading availability for consistency in accordance with the CAP theorem.

Bounded-Staleness Consistency allows stale reads within a time-bound, providing a middle ground between strong consistency and eventual consistency. The system employs multiple techniques to enforce bounded staleness. First, regarding anti-entropy with Merkle-Search Trees, the Class Runtime's ODGM employs anti-entropy techniques with Merkle-Search Trees to detect and repair inconsistencies within the defined window. Second, regarding Conflict-Free Replicated Data Types (CRDTs), CRDTs are used to manage out-of-order changes, allowing replicas to independently apply updates and converge to a consistent state without coordination. Third, regarding bounded-staleness enforcement, read and write access is blocked if network partitions exceed the allowed staleness window. This ensures that even during partial network failures, reads never see data that is stale beyond the specified bound such as between about 1 to about 10 seconds such as 1 second, 3 seconds, 5 seconds, or 10 seconds. This consistency model is particularly useful for applications that can tolerate some staleness but require bounds on how stale data can be, such as monitoring dashboards or analytics applications.

Read-Your-Write (RYW) Consistency ensures that a client's read operations always see the effects of its own prior write operations, even under network partition. This provides session consistency where clients see a consistent view of their own actions. The Class Runtime enforces RYW consistency by routing reads and writes from the same client through the object access API to the same local storage. This session affinity ensures that each client maintains a consistent view of its own operations; operations can continue locally even during network partitions; and different clients may see different views of the data through multi-master replication. This consistency model is well-suited for edge-cloud deployments where latency-sensitive operations must continue at the edge even when connectivity to the cloud is lost.

For applications prioritizing availability over consistency, the system supports eventual consistency where replicas may temporarily diverge but eventually converge when network connectivity is restored. Eventual consistency is appropriate for use cases such as social media feeds where immediate consistency is not critical, caching layers where stale data is acceptable, and aggregation and analytics where approximate results are sufficient.

The system also supports other consistency models. Sequential Consistency means all operations appear to execute in some sequential order that is consistent with the program order of each individual process. Linearization Consistency means operations appear to execute atomically at a single point in time between their invocation and response. These models provide stronger guarantees than eventual consistency but may have different performance characteristics than strong consistency implemented via Raft.

The choice of consistency model involves trade-offs between performance where weaker consistency models typically offer lower latency; availability where weaker consistency models can continue operating during partitions; and correctness where stronger consistency models provide more guarantees about data freshness. In embodiments, developers declaratively specify the desired consistency model through the SLA interface, and the system automatically configures the appropriate mechanisms to enforce that model. The system can support different consistency models for different classes or even different attributes within the same application, allowing fine-grained control over consistency requirements.

The system extends seamlessly across heterogeneous infrastructure spanning cloud and edge tiers. The system handles differences in container orchestration, using full-fledged Kubernetes distributions such as RKE2 in the cloud versus lightweight distributions such as K3s or K3d at the edge; resource capacity, managing high-capacity cloud servers versus resource-constrained edge nodes; and network characteristics, adapting to high-bandwidth, low-latency cloud networks versus variable-quality edge networks with intermittent connectivity. The platform agents at each tier adapt to local infrastructure characteristics while maintaining a unified abstraction for application developers.

For applications spanning multiple geographic regions, the system coordinates deployment across geographically dispersed data centers. In experimental deployments, the system has been demonstrated across data centers with significant geographic separation such as Texas and Illinois communicating over standard Internet connections with 33 milliseconds latency. The consistent hashing and locality enforcement mechanisms ensure that requests are routed to appropriate data centers to minimize latency while maintaining consistency guarantees.

For IoT applications, the system provides comprehensive device integration. First, regarding Device Agents, lightweight Device Agents run on IoT devices, providing protocol translation for MQTT, BLE, RFID, TCP, and other protocols; data buffering and batching; local processing capabilities; and connection management to edge infrastructure. Second, regarding Device Class Abstraction, heterogeneous IoT devices are modeled through a Device class abstraction that defines basic operations such as produce( ) to generate data from sensors, action( ) to perform actuation based on commands, and consume( ) to process incoming data or commands. Developers extend this base class to create device-specific implementations that handle protocol details and device-specific logic.

Third, regarding Fleet Manager Integration, the system integrates with existing IoT fleet management platforms including AWS IoT Core, Azure IoT Central, Eclipse IoT projects, and EdgeX Foundry. This integration is encapsulated within a polymorphic Fleet Manager class that abstracts away cloud-specific differences, allowing applications to work across multiple IoT platforms.

The Messaging Infrastructure supports topic-based, protocol-agnostic communication across tiers. In some embodiments, the system uses Zenoh, a low-latency pub/sub and query-based protocol optimized for edge-cloud communication. This enables efficient message passing between edge and cloud; support for publish/subscribe patterns; query-based communication beyond simple pub/sub; and automatic routing and discovery.

The Monitoring System continuously monitors network connectivity between tiers and detects network partitions through heartbeat mechanisms between platform agents, failed consensus attempts in strong consistency scenarios, and timeout detection in cross-tier communications.

Upon detecting network disruption, the system automatically adapts its behavior based on the specified consistency model. For Read-Your-Write Consistency, invocations are redirected to local edge infrastructure, operations continue using locally available data, and session consistency is maintained within the partition. For Bounded-Staleness Consistency, local operations continue within the staleness bound; if the partition duration exceeds the bound, operations are blocked; and synchronization occurs when connectivity is restored. For Strong Consistency, write operations are blocked if quorum cannot be achieved, read operations continue from available replicas, and operations resume when quorum is restored.

In some aspects, the system supports fault injection for testing resilience. In some embodiments, integration with Chaos Mesh allows controlled injection of network failures to validate system behavior under partitions.

When network connectivity is restored, several recovery mechanisms engage. First, regarding synchronization, divergent replicas are synchronized using the appropriate mechanisms for the consistency model, whether Raft consensus, CRDT merging, or Merkle tree reconciliation. Second, regarding request resumption, blocked operations are retried or completed. Third, regarding load rebalancing, workload distribution is optimized across all available tiers.

The system implements several techniques to optimize data locality. First, regarding consistent hashing, the system uses consistent hashing to track object data locations across distributed storage, route invocations to locations where data resides, and minimize data movement during scaling operations. Second, regarding co-location of compute and storage, when locality SLAs are specified, function containers are deployed on the same machines as object storage, in-memory caching reduces database access latency, and data transfer between compute and storage is minimized. Third, regarding pre-signed URLs, for large unstructured data or BLOBs, the system can generate pre-signed URLs allowing direct access between function containers and object storage, bypassing intermediate components and reducing latency.

Several mechanisms minimize or eliminate cold start latency. First, regarding container pre-warming, based on throughput SLAs, the system pre-warms sufficient containers to handle the guaranteed invocation rate without cold starts. Second, regarding container keep-alive, containers are kept alive for recently active objects, reducing the frequency of cold starts for workloads with temporal locality. Third, regarding sandbox recycling, the system can recycle execution sandboxes across invocations of the same function, amortizing initialization costs.

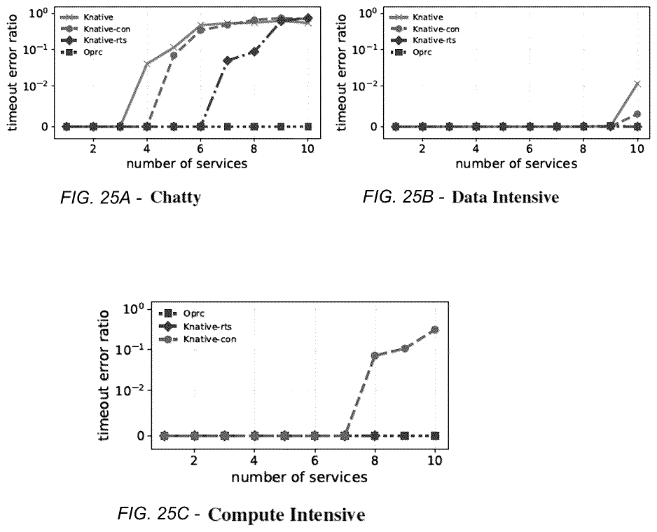

First, regarding guaranteed rate management, the system calculates resource requirements based on target throughput specifications, historical execution time statistics, concurrency limits, and CPU and memory requirements. Second, regarding adaptive scaling, resources are dynamically adjusted based on actual workload patterns, QoS compliance metrics, resource availability, and cost constraints. Third, regarding multi-service awareness, when multiple services coexist, the system prevents resource contention through service-specific allocations, adjusts resource distribution based on relative priorities, and maintains individual service QoS guarantees. FIGS. 25A-25C show the error response ratio of different solutions upon deploying them with different numbers of services, demonstrating that Oparaca maintains zero timeout errors across multiple concurrent services while other baselines experience increasing error rates.

For edge-cloud IoT applications, the system and processes establishe a two-stage development process. In Stage 1, Conceptual Modeling, developers model essential components and workflows using the unified abstraction by defining Device classes for IoT devices, defining Service classes for application logic, specifying data flow and communication patterns, and declaring SLAs for each component. This stage creates a high-level blueprint that abstracts away infrastructure complexities. In Stage 2, Implementation, developers extend conceptual classes with specific device implementations including protocol handling and data formats, service logic implementations including processing algorithms, and SLA refinements including specific consistency models and performance targets. The enriched definitions are submitted to the platform, which handles all deployment details automatically.

Embodiments of the present systems and methods can reduce development effort. Regarding lines of code reduction, there is a 44.5 percent reduction in application logic code compared to traditional FaaS implementations. Regarding configuration code reduction, there is a 10-fold reduction in configuration code, for example, 417 lines of configuration code reduced to 39 lines. Regarding component system, traditional FaaS requires managing 7 or more distinct components, while the system consolidates to 4 unified object classes.

Human subject studies demonstrate improvements in learning curve and development speed. Regarding learning curve, there are higher quiz scores on the system's concepts, ranging from 84.6 percent to 92.0 percent, compared to traditional FaaS, ranging from 80.0 percent to 88.0 percent, with consistent improvement across all experience levels including unfamiliar, basic, and competent users. Regarding development speed, there is 31 percent faster task completion, with the system, while maintaining comparable code quality. These improvements indicate that the system's abstractions are not only more powerful but also more intuitive and easier to learn than traditional FaaS approaches.

An exemplary use case demonstrates the system's advantages for IoT applications. In a traditional FaaS implementation, the system requires multiple components including AWS IoT Core or Azure IoT Central for device registration; protocol-specific consumer functions such as RFID over MQTT, Video over TCP, and Beacon over BLE; a message broker such as RabbitMQ for event routing; multiple data stores including fast cache and critical database; analytics functions; data discovery services; and manual configuration of placement, networking, and QoS. The total implementation requires 666 lines of code, 417 lines of configuration code, and management of 7 or more components.

In contrast, an implementation using the present system uses unified object classes including Fleet Manager class that is polymorphic across AWS and Azure, Device Data Consumer class that is extensible for device types, Data Service class providing unified storage interface, and Data Discovery Service class for analytics, with declarative SLAs for consistency, locality, and throughput. The total implementation requires 363 lines of code, 39 lines of configuration code, and 4 unified classes. The results show 44.5 percent code reduction, 10-fold configuration reduction, and automated QoS enforcement without manual tuning.

FIGS. 14A-14B provide a visual comparison of developing and deploying a real-time inventory management system with FaaS-based solutions using AWS and Azure services versus using EdgeWeaver, illustrating how EdgeWeaver reduces component interactions and eliminates the verify-and-tune loop.

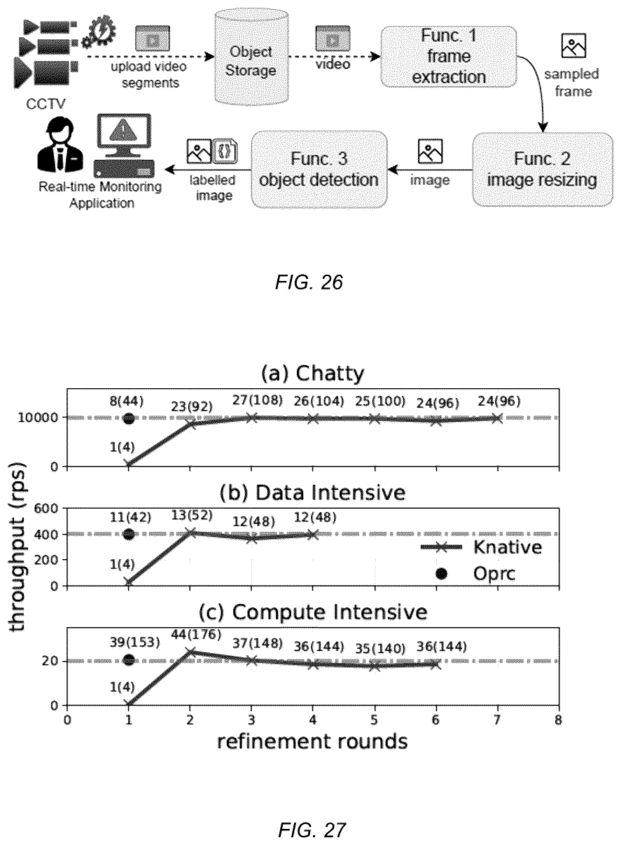

Another use case involves video processing, for example for surveillance systems. The application requirements include CCTV systems uploading video segments, frame extraction from video, image resizing for object detection, object detection with JSON labeling, and guaranteed throughput based on camera count and detection frequency. FIG. 26 shows the case study of developing video and image processing for a real-time monitoring system, illustrating how CCTV systems upload video segments to object storage where they are processed by a workflow of functions.

Implementation with the system uses three classes with inheritance. The Video class includes the extractFrame function returning LabeledImage and the wfDetectObject function with input frequency, along with a videoFile attribute of type blob. The Image class includes the resize function returning Image, along with an imageFile attribute of type blob. The LabeledImage class extends the Image class and includes the objectDetection function returning LabeledImage, along with a labels attribute of type json, with QoS throughput calculated from camera count. The system automatically manages data persistence across workflow stages, enforces throughput guarantees, optimizes data locality, and handles state transitions between processing stages.

For data-intensive applications with frequent small communications, the workload characteristics include frequent small database operations and significant network I/O overhead requiring low-latency access to document database. The system provides advantages through its internal in-memory DHT that reduces database operations, consistent hashing that ensures data locality, and up to 60 times throughput improvement over baseline FaaS.

For applications with substantial data access requirements, the workload characteristics include large file transfers from object storage, processing of binary image data, and output to object storage. The system provides advantages through pre-signed URLs that enable direct storage access, co-location of compute and storage when possible, and automatic scaling to meet throughput targets.

For computationally demanding applications, the workload characteristics include CPU-intensive video encoding and decoding, large input and output files, and long-running operations. The system provides advantages through appropriate CPU allocation via throughput enforcement, efficient container management, and comparable performance to manual tuning without refinement effort.

Embodiments of the system can be implemented using various open-source and commercial components. For container orchestration, the system can use Kubernetes or RKE2 for cloud and K3s or K3d for edge. For FaaS engines, the system can use Knative, OpenFaaS, or Fission. For storage systems, the system can use MinIO for S3-compatible object storage, ArangoDB for document database, or embedded in-memory storage in ODGM. For consensus and replication, the system can use OpenRaft for Raft implementation, CRDTs for bounded staleness, or Merkle-Search Trees for anti-entropy. For communication, the system can use Zenoh for low-latency pub/sub, or MQTT and Kafka as alternative messaging. For monitoring, the system can use Prometheus for metrics collection or custom monitoring agents. For chaos engineering, the system can use Chaos Mesh for fault injection.

The system supports multiple specification formats including YAML for class definitions, Python for function implementations, REST APIs for runtime interactions, and gRPC for high-performance inter-component communication.

The platform can integrate with multiple cloud providers. For AWS, the system can integrate with AWS Lambda for FaaS, AWS IoT Core for device management, Amazon S3 for object storage, and Amazon RDS for databases. For Azure, the system can integrate with Azure Functions for FaaS, Azure IoT Central for device management, Azure Blob Storage for objects, and Azure Cosmos DB for databases. For Google Cloud, the system can integrate with Google Cloud Functions for FaaS, Google Cloud IoT Core for devices, Google Cloud Storage for objects, and Google Cloud Spanner for databases. For Private Cloud, the system can integrate with OpenStack-based private clouds, VMware-based infrastructures, and bare-metal Kubernetes clusters.

While the description provided herein focuses on the LTAG template, other class runtime templates can be implemented for different requirement combinations. A Compute-Optimized Template focuses on CPU-intensive workloads, minimizes scheduling overhead, and optimizes container density. A Storage-Optimized Template prioritizes data access patterns, implements advanced caching strategies, and optimizes for large data transfers. A Cost-Optimized Template balances QoS with budget constraints, uses spot instances where appropriate, and implements aggressive resource sharing. A Security-Optimized Template enforces data encryption SLAs, implements secure multi-tenancy, and provides audit logging and compliance features.

In some aspects, additional consistency models can be supported. Causal Consistency preserves causally-related operations order, allows concurrent operations to reorder, and is useful for collaborative applications. Session Consistency extends RYW with monotonic reads and writes, provides per-session linearizability, and is suitable for user-facing applications. Timeline Consistency orders operations by physical timestamps, requires synchronized clocks such as TrueTime, and enables globally consistent snapshots.

In some aspects, additional QoS requirements can be supported. Energy Efficiency minimizes power consumption, optimizes for carbon footprint, and supports green computing initiatives. Cost Optimization minimizes monetary cost, balances cost against performance, and supports budget constraints. Security Level specifies encryption algorithms, defines access control policies, and enforces compliance requirements. Data Sovereignty ensures data stays within jurisdiction, supports GDPR and other regulations, and controls cross-border data flow.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

### Throughput Enforcement

Experimental evaluations demonstrate reliable throughput enforcement. The methodology involved deploying applications with various target throughputs, configuring load generators to match target rates, and measuring actual achieved throughput. The results show that the system consistently meets target throughput across all application types. Baseline FaaS such as Knative fails at high throughput targets due to internal queue saturation in chatty workloads, timeout issues in compute-intensive workloads, and lack of throughput awareness in auto-scaling. The implications are that even with the same backend services, manual FaaS configuration requires daunting effort to achieve desired throughput, while the system automates this through its high-level interface.

FIGS. 9A-9C show achievable throughput varying target throughput for chatty, data intensive, and compute intensive workloads, demonstrating that Oparaca ensures the actual throughput matches the target one across settings while other approaches including Knative, Knative-con, and Knative-rts fail to do so at high targets.

### Example 2

### Latency Optimization

Latency experiments under bursty loads show significant improvements. Baseline Knative suffers from up to 60 times higher latency than ideal due to cold starts under bursts and external storage causing data transmission overhead. The system with locality only shows 1.5 to 4 times improvement through data co-location, minimizing data transmission latency. The system with locality plus throughput shows additional 1.7 to 46.5 times improvement through cold start elimination, achieving 93 percent efficiency meaning only 7 percent overhead compared to ideal, with invocation overhead minimized to near-optimal levels.

FIG. 11 demonstrates that Oparaca can exploit data locality to provide various latency guarantees, showing normalized latency for chatty, data intensive, and compute intensive workloads comparing Knative against Oparaca with local deployment, Oparaca with local plus warm deployment, and ideal deployment scenarios.

### Example 3

### Availability and Reliability

Ultra-high availability testing demonstrates improved results. For four nines availability of 99.99 percent, the system requires 2 to 3 replicas as an industry standard baseline achievable with modest resource increase. For nine nines availability of 99.999999999 percent, which is 10,000 times more reliable than four nines, the system requires 9 replicas with only 3 times cost increase for 10,000 times reliability improvement, far exceeding current industry standards such as AWS Lambda's 99.95 percent. Under nine nines availability, bounded staleness remains under specified thresholds, strong consistency achieves zero staleness, write latency increases by at most 2 times, and weaker consistency models show negligible impact.

FIG. 10 shows successful invocation rates at different availability targets with availability enforcement, where the resource stability P is 94.36 percent, demonstrating that when availability enforcement is enabled, Oparaca deploys classes and objects with replications that significantly reduce the failure rate to meet the availability targets.

### Example 4

### Scalability

Scalability experiments demonstrate strong performance. For compute-intensive workload such as object detection, there is nearly linear scaling up to 256 vCPUs with 70 times throughput gain from 4 to 256 vCPUs, peaking at 144 invocations per second at 256 vCPUs. For data-intensive workload such as JSON processing, the system scales to 200,000 invocations per second at 256 vCPUs with moderate scaling due to I/O intensity while maintaining efficiency across scaling range. For edge scaling, throughput scales proportionally with edge count at 8 vCPU per edge node, demonstrating horizontal scaling capability.

FIGS. 15A-15C show the scalability analysis of EdgeWeaver across Edge-Cloud deployment, cloud-only deployment, and edge-only deployment, demonstrating throughput scaling for both compute-intensive detect workload and data-intensive analyze workload.

### Example 5

### Deployment Productivity

Manual refinement experiments show significant productivity improvements. Traditional FaaS such as Knative requires 4 to 8 rounds of manual refinement through a three-phase process that includes finding approximate pod count through multiple iterations, fine-tuning pod count, and optimizing concurrency settings. This requires resource-domain expertise and is a time-consuming trial-and-error process. In contrast, the system requires zero manual refinement rounds with automatic adjustment during initial load. In some cases, such as chatty workload, there is 56 percent resource reduction from 100 to 44 cores due to locality optimization. In other cases, such as compute-intensive workload, there is comparable resource usage of 144 versus 153 cores, which is only 6 percent increase, with zero manual effort.

Regarding resource efficiency across multiple concurrent services, the system maintains zero timeout errors up to 10 services, while baselines experience increasing error rates due to lack of service-specific awareness, resource contention, and independent scaling without coordination.

FIG. 27 shows rounds of refinement for Knative to enforce the target throughput versus Oparaca for chatty, data intensive, and compute intensive workloads, with data points annotated by number of pods and number of cores including invoker pods, demonstrating that the manual refinement method needs at least 4 rounds while Oparaca automatically adjusts deployment.

### Example 6

### Network Partition Adaptation

Fault injection experiments demonstrate robust adaptation. For Read-Your-Write Consistency, invocations redirect to edge during partition, operation continuity is maintained, and throughput may fluctuate without throughput SLA. For RYW with Throughput SLA, stable 4,000 requests per second is maintained during partition with quick recovery upon network restoration, demonstrating benefit of combined SLAs. For Strong Consistency, throughput drops to zero during partition, which is correct behavior, data correctness is preserved by blocking operations, and immediate resumption occurs when quorum is restored. These results validate the system's fine-grained adaptability and ability to balance QoS desires dynamically.

FIG. 13 shows the impact of network partitioning for classes with RYW, RYW with throughput, and Strong Consistency, illustrating cloud execution and edge execution throughput over time with a network partition period indicated, demonstrating how EdgeWeaver automatically adapts by redirecting invocations and maintains appropriate behavior based on consistency requirements.

Having described various systems, methods, and processes, certain aspects can include, but are not limited to:

In a first aspect, a method for providing enhanced serverless computing to a plurality of users across cloud and edge infrastructure, comprising: modeling a plurality of functions as a set of object classes, wherein each object class comprises one or more methods implemented as serverless functions, one or more attributes representing application state, and a set of declarative service level agreements (SLAs) specifying non-functional requirements; deploying said plurality of functions on one or more computing tiers spanning cloud datacenters and edge nodes; creating one or more class runtimes from class runtime templates to manage said object classes, wherein said class runtime templates are selected based on said SLAs and infrastructure characteristics; allocating computing resources across said computing tiers to satisfy said SLAs; and automatically enforcing said SLAs through runtime adaptation without manual intervention.

In a second aspect, a system for unified object-based serverless computing across a heterogeneous infrastructure continuum, comprising: a package manager configured to receive class definitions specifying object-oriented structures with methods, attributes, and SLAs, and to distribute said class definitions to platform agents across multiple computing tiers; a class runtime manager at each computing tier configured to select appropriate class runtime templates based on SLAs and local infrastructure characteristics, to instantiate class runtimes for managing object instances, and to monitor SLA compliance metrics; a plurality of class runtimes configured to execute serverless functions implementing object methods, to manage object state in storage systems, to enforce consistency guarantees, and to coordinate cross-tier communication; a messaging infrastructure providing topic-based, protocol-agnostic communication across computing tiers; and a monitoring system configured to collect performance and availability metrics, to detect network partitions and infrastructure failures, and to trigger adaptive responses to maintain SLA compliance.

In a third aspect, a method for enforcing quality-of-service requirements in serverless applications spanning cloud and edge environments, comprising: receiving a declarative specification of SLAs for an application, wherein said SLAs include one or more of throughput requirements in requests per second, availability requirements as percentage of uptime, consistency requirements selected from strong consistency, bounded-staleness consistency, read-your-write consistency, eventual consistency, sequential consistency, and linearization consistency, and locality requirements specifying preferred deployment locations; determining a replication factor based on said availability requirements and infrastructure stability metrics; deploying application components across a calculated number of computing tiers to achieve said replication factor; configuring consistency enforcement mechanisms based on said consistency requirements, including implementing consensus protocols for strong consistency, implementing conflict-free replicated data types (CRDTs) and anti-entropy for bounded-staleness consistency, and implementing session affinity for read-your-write consistency; allocating computing resources to guarantee said throughput requirements through container pre-warming and resource reservation; routing application requests using consistent hashing to enforce locality requirements; continuously monitoring SLA compliance; and automatically adapting resource allocation and request routing in response to workload changes and network conditions.

A fourth aspect can include the first aspect, wherein said class runtime templates include a latency, throughput, and availability guarantee (LTAG) template comprising: an invoker module maintaining an in-memory distributed hash table (DHT) for object data; a function-as-a-service (FaaS) engine executing function logic in containers; and a storage module supporting both structured and unstructured data with automatic data loader and writer components.

A fifth aspect can include the first aspect or the fourth aspect, wherein said class runtime templates are configurable and customizable based on specific deployment scenarios and provider optimization objectives.

A sixth aspect can include the second aspect, further comprising device agents deployed on Internet-of-Things (IoT) devices, wherein said device agents: expose platform-specific APIs for device integration; perform protocol translation for heterogeneous communication protocols including MQTT, BLE, RFID, and TCP; buffer and batch data for efficient transmission; and provide local processing capabilities.

A seventh aspect can include the second aspect or the sixth aspect, wherein said class runtimes include an Object Data Grid Manager (ODGM) configured to: route object method invocations; manage data consistency across replicas; coordinate cross-datacenter communication using low-latency messaging protocols; and provide object access APIs enforcing consistency guarantees before data operations.

An eighth aspect can include the first aspect, the fourth aspect, or the fifth aspect, further comprising: deploying said class runtimes across geographically dispersed datacenters; using consistent hashing to track object data locations across said datacenters; and routing invocations to locations where corresponding object data resides to minimize data transmission latency.

A ninth aspect can include the first aspect, the fourth aspect, the fifth aspect, or the eighth aspect, wherein said set of declarative service level agreements (SLAs) comprises one or more of: throughput specified as minimum invocations per second; availability specified as percentage of time an object must be available; locality specified as preferred datacenters or co-location requirements; consistency model selected from strong, bounded-staleness with time parameter, read-your-write, eventual, sequential, and linearization; persistence requirements specifying data durability; runtime requirements specifying execution environment configurations; budget constraints specifying maximum monetary cost; jurisdiction constraints specifying allowed deployment locations; and data encryption requirements specifying security algorithms.

A tenth aspect can include the ninth aspect, wherein said SLAs are specified hierarchically at one or more of: class level applying to all methods and attributes of an object class; method level applying to specific functions and overriding class-level SLAs; and attribute level applying to specific data elements.

An eleventh aspect can include the ninth aspect or the tenth aspect, wherein said SLAs are inherited through object-oriented inheritance, wherein: a child class inherits SLAs from a parent class; method-specific SLAs override inherited class-level SLAs; and multiple inheritance is supported with conflict resolution rules.

A twelfth aspect can include the third aspect, wherein enforcing strong consistency comprises: integrating a Raft consensus protocol into object access APIs; requiring write operations to be committed to a majority of replicas before acknowledgment; blocking write operations during network partitions preventing quorum; maintaining linearizability guarantees for all operations; and automatically resuming operations when quorum is restored.

A thirteenth aspect can include the third aspect or the twelfth aspect, wherein enforcing bounded-staleness consistency comprises: implementing conflict-free replicated data types (CRDTs) for handling out-of-order updates; using Merkle-Search Trees for detecting and repairing inconsistencies; specifying a staleness bound parameter in seconds; allowing read operations on data within said staleness bound; blocking read operations if network partitions exceed said staleness bound; and synchronizing replicas using anti-entropy techniques when connectivity is restored.

A fourteenth aspect can include the third aspect, the twelfth aspect, or the thirteenth aspect, wherein enforcing read-your-write consistency comprises: maintaining session affinity by routing reads and writes from a client to the same storage location; allowing continued operation at edge nodes during cloud connectivity loss; ensuring each client sees effects of its own prior writes;

permitting different clients to see different views of data; and synchronizing divergent views when network connectivity is restored.

A fifteenth aspect can include the third aspect, the twelfth aspect, the thirteenth aspect, or the fourteenth aspect, wherein said consistency enforcement mechanisms are adaptively selected based on: current network conditions including partition status; application requirements specified in SLAs; resource availability at each computing tier; and trade-offs between consistency guarantees and operation availability.

A sixteenth aspect can include the third aspect, wherein guaranteeing said throughput requirements comprises: calculating required computing resources based on target throughput specifications, historical execution time statistics, container concurrency limits, and CPU and memory requirements; pre-warming containers to eliminate cold-start latency; reserving sufficient resources at specified computing tiers; periodically adjusting resource allocations based on actual workload; and maintaining guaranteed invocation rates without queuing delays.

A seventeenth aspect can include the third aspect or the sixteenth aspect, wherein determining said replication factor comprises: calculating N equals the ceiling of log of one minus A divided by log of one minus P, where A is the target availability percentage, P is the stability of computing resources, and N is the number of replicas required; estimating P based on historical uptime metrics, network reliability statistics, hardware failure rates, and data center tier ratings; selecting computing tiers to host said N replicas based on locality constraints specified in SLAs, resource availability at candidate tiers, cost optimization objectives, and jurisdiction requirements; and deploying replicas with primary-replica coordination where one replica is active and others serve as standby.

An eighteenth aspect can include the seventeenth aspect, wherein said replication enables achievement of nine nines availability (99.999999999%) through: deploying nine replicas across diverse computing tiers; ensuring replicas are deployed in failure-independent locations; implementing automatic failover when primary replica fails; and maintaining said nine nines availability at only three times the cost of four nines availability (99.99%).

A nineteenth aspect can include the third aspect, the sixteenth aspect, the seventeenth aspect, or the eighteenth aspect, wherein enforcing locality requirements comprises: using consistent hashing to track object data locations; routing invocations to computing tiers where object data resides; co-locating function containers and object storage on same physical machines when specified; generating pre-signed URLs for direct storage access to minimize intermediate data transfers; maintaining in-memory caches of frequently accessed data at preferred locations; and prioritizing local execution over remote execution when locality is specified.

A twentieth aspect can include the first aspect, the fourth aspect, the fifth aspect, the eighth aspect, or the ninth aspect, further comprising minimizing invocation latency through: eliminating cold starts via container pre-warming for throughput-guaranteed functions; enforcing data locality to minimize network transmission overhead; maintaining in-memory distributed hash tables (DHT) for rapid data access; using pre-signed URLs for direct object storage access; co-locating compute and storage resources; and achieving invocation overhead of less than 7 percent compared to ideal execution environment.

A twenty-first aspect can include the twentieth aspect, wherein said latency minimization achieves: 1.5 to 4 times improvement through data co-location alone compared to baseline FaaS; additional 1.7 to 46.5 times improvement through cold start elimination; and overall latency within 7 percent of ideal execution environment.

A twenty-second aspect can include the second aspect, the sixth aspect, or the seventh aspect, wherein said heterogeneous infrastructure continuum comprises: cloud datacenters running full Kubernetes distributions with high resource capacity; edge nodes running lightweight Kubernetes distributions including K3s and K3d with resource constraints; IoT devices running device agents with protocol translation capabilities; geographically dispersed locations with varying network characteristics including high-bandwidth low-latency cloud networks, variable-quality edge networks with intermittent connectivity, and device networks using protocols including MQTT, BLE, and RFID; and messaging infrastructure providing unified communication across all tiers.

A twenty-third aspect can include the first aspect, the fourth aspect, the fifth aspect, the eighth aspect, or the ninth aspect, further comprising integrating with IoT fleet management platforms including: AWS IoT Core; Azure IoT Central; Eclipse IoT projects; and EdgeX Foundry; wherein said integration is encapsulated within a polymorphic Fleet Manager class abstracting cloud-specific differences.

A twenty-fourth aspect can include the first aspect, the fourth aspect, the fifth aspect, the eighth aspect, the ninth aspect, or the twenty-third aspect, further comprising modeling IoT devices through a Device class defining operations including: produce( ) for generating sensor data; action ( ) for performing actuation commands; and consume( ) for processing incoming data; wherein developers extend said Device class to create device-specific implementations handling protocol details.

A twenty-fifth aspect can include the second aspect, the sixth aspect, the seventh aspect, or the twenty-second aspect, wherein said messaging infrastructure comprises: a low-latency publish/subscribe protocol supporting edge-cloud communication; query-based communication capabilities beyond simple pub/sub patterns; automatic message routing and service discovery; topic-based addressing enabling protocol-agnostic communication; efficient batching and compression for constrained networks; and support for various underlying protocols including Zenoh, MQTT, and Kafka.

A twenty-sixth aspect can include the third aspect, the twelfth aspect, the thirteenth aspect, the fourteenth aspect, or the fifteenth aspect, further comprising adapting to network partitions through: detecting network disruptions via heartbeat mechanisms between platform agents, failed consensus attempts, and timeout detection in cross-tier communications; adapting operation behavior based on consistency model: for read-your-write consistency by redirecting operations to local infrastructure, for bounded-staleness consistency by continuing within staleness bound or blocking, and for strong consistency by blocking write operations preventing quorum; synchronizing divergent replicas upon connectivity restoration using Raft consensus for strong consistency, CRDT merging for bounded-staleness, and Merkle tree reconciliation for eventual consistency; and resuming blocked operations and rebalancing workload across tiers.

A twenty-seventh aspect can include the twenty-sixth aspect, further comprising: injecting controlled network faults for testing using chaos engineering tools; validating system behavior under various partition scenarios; measuring recovery time and data divergence during partitions; and ensuring SLA compliance is restored upon partition resolution.

A twenty-eighth aspect can include the second aspect, the sixth aspect, the seventh aspect, the twenty-second aspect, or the twenty-fifth aspect, wherein each platform agent includes: a monitoring system continuously collecting metrics including network connectivity status, consensus success and failure rates, cross-tier communication latencies, and SLA compliance measurements; a class runtime manager implementing a localized control loop that detects infrastructure and network changes, automatically adapts resource allocation, triggers failover procedures, and maintains SLA compliance without central coordination; and decision-making capabilities enabling autonomous tier-specific adaptation while maintaining global consistency.

A twenty-ninth aspect can include the first aspect, the fourth aspect, the fifth aspect, the eighth aspect, or the ninth aspect, further comprising a two-stage development process including: a conceptual modeling stage wherein developers model components using unified object abstraction, define device classes for Internet-of-Things (IoT) devices, define service classes for application logic, specify data flow and communication patterns, and declare SLAs for each component; an implementation stage wherein developers extend conceptual classes with specific implementations, associate refined SLAs with classes, methods, and attributes, and submit enriched class definitions to platform; and wherein said platform automatically extracts logic, state, and communication patterns, instantiates concrete infrastructure components, deploys across appropriate computing tiers, and enforces SLAs without manual configuration.

A thirtieth aspect can include the twenty-ninth aspect, achieving: 44.5 percent reduction in lines of code compared to traditional FaaS implementations; 10-fold reduction in configuration code; reduction from 7 or more managed components to 4 unified object classes; 31 percent faster development time based on human subject studies; and zero manual refinement rounds compared to 4 to 8 rounds for traditional FaaS.

A thirty-first aspect can include the first aspect, the fourth aspect, the fifth aspect, the eighth aspect, the ninth aspect, or the twenty-ninth aspect, providing a declarative interface supporting specification in formats including: YAML for class definitions; Python for function implementations; JSON for attribute schemas; and REST APIs for runtime interactions; wherein said interface abstracts low-level details including container orchestration configurations, network setup and protocol selection, storage provisioning and management, replication and consistency mechanisms, and resource allocation and scaling policies.

A thirty-second aspect can include the first aspect, the fourth aspect, the fifth aspect, the eighth aspect, the ninth aspect, the twentieth aspect, or the twenty-ninth aspect, further comprising optimizing performance through: using consistent hashing for efficient object data location tracking; maintaining in-memory distributed hash tables (DHT) at invoker modules; implementing pure function approach bundling invocations with object attributes; returning updated attributes from functions to invokers for caching; minimizing database access operations through caching; generating pre-signed URLs for direct storage access avoiding intermediate components; and co-locating containers and storage on same machines when locality is specified.

A thirty-third aspect can include the first aspect, the fourth aspect, the fifth aspect, the eighth aspect, the ninth aspect, the twentieth aspect, the twenty-ninth aspect, or the thirty-second aspect, achieving performance improvements including: 60 times performance enhancement through latency and throughput enforcement; 50 times reliability improvement through availability enforcement; 70 times throughput scaling while maintaining SLA compliance; 200,000 invocations per second for data-intensive workloads; 144 invocations per second for compute-intensive workloads with near-linear scaling; write latency within 100 milliseconds for strong consistency at scale; and write latency within 20 milliseconds for weaker consistency models.

A thirty-fourth aspect can include the third aspect, the twelfth aspect, the thirteenth aspect, the fourteenth aspect, the fifteenth aspect, the sixteenth aspect, the seventeenth aspect, the eighteenth aspect, the nineteenth aspect, or the twenty-sixth aspect, wherein said automatic adaptation maintains: zero timeout errors across multiple concurrent services; stable throughput during network partitions for read-your-write consistency with throughput SLA; immediate operation resumption upon partition resolution; proportional resource allocation across replicas based on availability; service-specific resource allocations preventing contention; and individual service QoS guarantees in multi-service deployments.

A thirty-fifth aspect can include the first aspect, the fourth aspect, or the fifth aspect, wherein said class runtime templates include specialized templates for: compute-optimized workloads focusing on CPU-intensive operations; storage-optimized workloads prioritizing data access patterns; cost-optimized deployments balancing QoS with budget constraints; and security-optimized deployments enforcing encryption and compliance; wherein each template provides configurable parameters for customization based on specific application requirements, infrastructure characteristics, provider optimization objectives, and cost and performance trade-offs.

A thirty-sixth aspect can include the second aspect, the sixth aspect, the seventh aspect, the twenty-second aspect, the twenty-fifth aspect, or the twenty-eighth aspect, wherein said class runtime manager is further configured to: maintain a library of class runtime templates; evaluate incoming class definitions against template selection criteria including specified SLAs and their combinations, infrastructure capabilities at target tiers, workload characteristics and patterns, and cost and efficiency objectives; select optimal template from said library based on said evaluation; instantiate customized class runtime from selected template; configure said class runtime with class-specific parameters; and enable addition of new templates without modifying existing system components.

A thirty-seventh aspect can include the first aspect, the fourth aspect, the fifth aspect, the eighth aspect, the ninth aspect, the tenth aspect, the eleventh aspect, the twenty-ninth aspect, or the thirty-first aspect, further comprising supporting object-oriented programming features including: inheritance wherein child classes inherit methods from parent classes, attributes from parent classes, and SLAs from parent classes with override capability; polymorphism enabling different implementations of same interface, runtime selection of appropriate implementation, and abstraction of cloud-specific differences; encapsulation providing access control through access modifiers, information hiding of implementation details, and clear separation between interface and implementation; abstract classes defining common interfaces for related classes, partial implementations extensible by concrete classes, and reusable components across application; and composition enabling objects to contain references to other objects, complex structures from simple components, and modular application architectures.

A thirty-eighth aspect can include the second aspect, the sixth aspect, the seventh aspect, the twenty-second aspect, the twenty-fifth aspect, the twenty-eighth aspect, or the thirty-sixth aspect, wherein said monitoring system is configured to: collect metrics including function invocation counts and latencies, storage access patterns and volumes, network bandwidth and latencies, resource utilization including CPU, memory, and storage, SLA compliance measurements, availability and uptime statistics, consistency enforcement overhead, and replication lag and divergence; aggregate metrics across individual object instances, class-level summaries, tier-level summaries, and application-wide statistics; detect violations including throughput falling below guaranteed rate, availability dropping below target percentage, latency exceeding acceptable thresholds, and consistency guarantees not being maintained; and trigger corrective actions including resource reallocation, replica instantiation or removal, request routing changes, failover procedures, and administrative alerts.

A thirty-ninth aspect can include the first aspect, the fourth aspect, the fifth aspect, the eighth aspect, the ninth aspect, the twentieth aspect, the twenty-ninth aspect, the thirty-first aspect, the thirty-second aspect, or the thirty-third aspect, further comprising lifecycle management including: a registration phase wherein developer submits class definitions with SLAs, package manager unpacks deployment extracting logic, state, and SLAs, class runtime manager selects appropriate template, and class runtime is generated and deployed; an execution phase wherein class runtime manages all object instances of associated class, users interact with objects via provided APIs, invocations are routed through messaging infrastructure, and SLAs are enforced automatically; a monitoring phase wherein metrics are continuously collected, SLA compliance is verified, and violations trigger adaptation; and an adaptation phase wherein resources are reallocated as needed, failed components are recovered, configuration is adjusted based on workload, all without developer intervention.

A fortieth aspect can include the first aspect, the fourth aspect, the fifth aspect, the eighth aspect, the ninth aspect, the twentieth aspect, the twenty-third aspect, the twenty-ninth aspect, the thirty-first aspect, the thirty-second aspect, the thirty-third aspect, or the thirty-ninth aspect, further comprising: supporting multiple cloud providers including AWS, Azure, Google Cloud, and private clouds; abstracting provider-specific differences through polymorphic fleet manager classes, unified storage interfaces, protocol-agnostic messaging, and portable class definitions; enabling migration between providers through redeployment of same class definitions, automatic infrastructure adaptation, and SLA preservation across providers; and providing vendor neutrality allowing multi-cloud deployments, hybrid cloud-private cloud deployments, and avoidance of vendor lock-in.

While embodiments have been shown and described, modifications thereof can be made by one skilled in the art without departing from the spirit and teachings of this disclosure. The embodiments described herein are exemplary only, and are not intended to be limiting. It should be understood that any exemplary information herein represents a non-limiting example. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=RI+k*(Ru−RI), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

It should be understood that relative terms such as “hot,” “cold,” “hotter,” “cooler,” “colder,” are relative terms and do not denote any specific number or range (but rather a relative value with respect to some other aspect). For example, reference to a hot fluid means that the fluid is hotter than a cool fluid of the system and/or has been heated, while reference to a cool fluid means a fluid that is cooler/colder than a hot fluid of the system and/or has not been heated or has been heated less than the fluid of another portion of the system (for example another portion of the system with which the fluid is interacting).

Accordingly, the scope of protection is not limited by the description set out above, but is intended to be inclusive. For example, any appendices hereto are fully incorporated herein. The claims which follow, illustrate the scope of some embodiments, and that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

What is claimed is:

1. A method for providing object-based serverless computing across distributed computing infrastructure, comprising:
receiving one or more class definitions, wherein each class definition encapsulates application logic as methods, application state as attributes, and quality-of-service requirements as declarative service level agreements (SLAs);
selecting one or more runtime templates based on said SLAs, wherein each runtime template defines a deployment architecture optimized for specific combinations of quality-of-service requirements;
instantiating one or more class runtimes from said selected runtime templates across one or more computing tiers;
deploying application components across said computing tiers according to said class runtimes; and
automatically enforcing said SLAs through resource allocation and runtime adaptation without manual configuration.

2. The method of claim 1, wherein said runtime templates comprise configurable architectures comprising: an invocation coordinator maintaining distributed state information for objects; a function execution engine managing containerized execution of methods; and a storage layer supporting both structured and unstructured data with configurable consistency guarantees.

3. The method of claim 1, wherein said declarative SLAs specify one or more of: minimum guaranteed throughput measured as invocations per time period; target availability measured as percentage uptime; consistency model selected from strong consistency, bounded-staleness consistency, read-your-write consistency, and eventual consistency; locality preferences specifying preferred computing locations or co-location requirements; persistence requirements; execution environment requirements; cost constraints; geographic restrictions; and security requirements.

4. The method of claim 3, wherein said SLAs are specified at multiple granularity levels comprising class level, method level, and attribute level, and wherein method-level and attribute-level SLAs override class-level SLAs.

5. The method of claim 1, further comprising:
modeling Internet-of-Things (IoT) devices as objects through extensible device classes defining device operations;
deploying lightweight agents on IoT devices to perform protocol translation, data buffering, and local processing; and
integrating with fleet management platforms through polymorphic abstractions that encapsulate platform-specific differences.

6. The method of claim 1, further comprising:
detecting and adapting to network partitions through: monitoring network connectivity between computing tiers using heartbeat mechanisms and operation success rates;
automatically modifying operation behavior based on consistency requirements, comprising redirecting operations to local infrastructure for session consistency, continuing within staleness bounds or blocking for bounded-staleness consistency, and blocking write operations for strong consistency;
synchronizing divergent replicas using appropriate techniques when connectivity is restored; and
resuming blocked operations and rebalancing workload.

7. The method of claim 1, further comprising:
improving performance through: using consistent hashing to track object data locations and route invocations to computing locations where data resides;
maintaining in-memory caches of object state to reduce storage access latency;
co-locating function execution environments and object storage when locality is specified;
generating direct access credentials for large data transfers; and
achieving invocation overhead of less than 10 percent compared to ideal execution.

8. The method of claim 1, further comprising:
supporting object-oriented programming features comprising: inheritance wherein child classes inherit methods, attributes, and SLAs from parent classes with override capability;
polymorphism enabling multiple implementations of common interfaces with runtime selection;
encapsulation providing access control and information hiding;
abstract classes defining extensible interfaces; and
composition enabling complex structures from multiple component objects.

9. The method of claim 1, wherein said class definitions are specified using human-readable declarative formats, and wherein said method or system abstracts infrastructure details comprising container orchestration, network configuration, storage provisioning, replication mechanisms, and resource scaling from developers.

10. The method of claim 1, further comprising:
achieving support for availability targets exceeding 99.999 percent.

11. A system for distributed object-based serverless computing, comprising:
a deployment manager configured to receive class definitions specifying object-oriented abstractions with methods, attributes, and service level agreements (SLAs), and to coordinate deployment across multiple computing tiers;
a runtime manager at each computing tier configured to select runtime templates based on SLAs and infrastructure characteristics, and to instantiate runtimes for managing objects;
a plurality of runtimes configured to execute functions implementing object methods, manage object state, enforce consistency requirements, and coordinate inter-tier communication;
a communication infrastructure providing location-transparent messaging across computing tiers; and
an adaptation system configured to monitor compliance with said SLAs and trigger automatic adjustments to resource allocation, replica placement, and request routing in response to workload changes, infrastructure conditions, and network events.

12. The system of claim 11, wherein said runtimes comprise a data coordination module configured to: route invocations based on data location; manage replication across multiple computing tiers; enforce consistency guarantees through consensus protocols, anti-entropy techniques, conflict-free replicated data types, or session affinity; and coordinate cross-tier communication using low-latency messaging protocols.

13. The system of claim 11, wherein said computing tiers comprise heterogeneous infrastructure comprising: cloud datacenters with high-capacity resources; edge nodes with constrained resources running lightweight orchestration systems; and Internet-of-Things (IoT) devices with device agents providing protocol translation and local processing; wherein said system maintains unified object abstractions across said heterogeneous infrastructure.

14. The system of claim 11, wherein said adaptation system is configured to: collect metrics comprising invocation latencies, throughput rates, storage access patterns, resource utilization, network connectivity status, and consistency enforcement overhead; aggregate metrics across objects, classes, computing tiers, and entire applications; detect SLA violations comprising throughput below guaranteed rates, availability below target percentages, and latency exceeding thresholds; and trigger corrective actions comprising resource reallocation, replica creation or removal, routing changes, and failover procedures.

15. A method for enforcing quality-of-service requirements in distributed serverless applications, comprising:
receiving declarative service level agreements (SLAs) specifying one or more of throughput requirements, availability requirements, consistency requirements, and locality requirements;
determining resource allocation across multiple computing tiers to satisfy said SLAs, comprising calculating a replication factor based on availability requirements and infrastructure reliability metrics;
deploying application components with pre-warmed execution environments to guarantee throughput requirements;
configuring data consistency mechanisms selected from consensus protocols, conflict-free replication, session-based consistency, and eventual consistency based on said consistency requirements;
routing requests to computing locations proximate to associated data using distributed hash-based tracking to enforce locality requirements;
continuously monitoring actual performance against said SLAs; and
dynamically adapting said resource allocation, replication factor, consistency mechanisms, and request routing in response to detected performance deviations, infrastructure changes, and network conditions.

16. The method of claim 15, wherein enforcing strong consistency comprises:
integrating a consensus protocol that requires agreement from a majority of replicas before completing write operations;
blocking write operations during network partitions that prevent achieving consensus quorum; maintaining linearizability guarantees; and
automatically resuming operations when connectivity and quorum are restored.

17. The method of claim 15, wherein enforcing bounded-staleness consistency comprises:
implementing conflict-free replicated data types to handle concurrent updates;
using anti-entropy techniques to detect and repair inconsistencies within a specified time bound;
allowing read operations on data within said time bound;
blocking operations when network partition duration exceeds said time bound; and
synchronizing replicas when connectivity is restored.

18. The method of claim 15, wherein enforcing read-your-write consistency comprises:
maintaining session affinity by routing a client's reads and writes to the same storage location;
allowing continued operation at edge computing locations during connectivity loss to cloud infrastructure;
ensuring each client observes effects of its own operations;
permitting different clients to observe different data states; and
synchronizing divergent states when connectivity is restored.

19. The method of claim 15, wherein guaranteeing throughput requirements comprises:
calculating required computational resources based on target throughput, historical execution statistics, and concurrency limits;
pre-warming execution environments to eliminate initialization latency; reserving resources at specified computing tiers; and
dynamically adjusting resource allocations based on actual workload patterns.

20. The method of claim 15, wherein determining said replication factor comprises:
calculating a number of replicas N using a formula based on target availability A and infrastructure stability P;
estimating infrastructure stability from historical metrics including uptime, network reliability, and failure rates;
selecting computing tiers for hosting replicas based on constraints including locality preferences, resource availability, cost objectives, and geographic restrictions; and
deploying replicas with primary-replica coordination.
